(19) United States
(12) Patent Application Publication
(10) Pub. No.: US 2026/0073404 A1
(43) Pub. Date: Mar. 12, 2026

(54) DEVICE FOR COMPLIANCE REQUIREMENT ANALYSIS AND INSPECTION AUTOMATION AND METHOD FOR CONTROLLING SAME

(71) Applicant: O.NE PEOPLE CO., LTD., Seoul (KR)

(72) Inventor: A Young CHO, Seoul (KR)

(73) Assignee: O.NE PEOPLE CO., LTD., Seoul (KR)

(21) Appl. No.: 19/386,581

(22) Filed: Nov. 12, 2025

Related U.S. Application Data
(63) Continuation of application No. PCT/KR2024/019753, filed on Dec. 4, 2024.

(30) Foreign Application Priority Data
Dec. 5, 2023 (KR) 10-2023-0173950
Nov. 29, 2024 (KR) 10-2024-0174475

(51) Int. Cl. G06Q 30/018

(52) U.S. Cl. CPC G06Q 30/018

(57) ABSTRACT

The present disclosure relates to a device for compliance requirement analysis and inspection automation and a method for controlling the same, and has the technical feature of collecting regulatory data on personal information by country; classifying and relearning a policy tag based on the collected regulatory data; analyzing at least one of a company's contract, a term and condition, a policy, a guideline, or a personal information processing policy included in the regulatory data to classify the company's security requirement into a personal information lifecycle and a security control item; verifying compliance with the security requirement; and managing risk assessment and risk management based on the verified result.

### CROSS-REFERENCE TO RELATED APPLICATIONS

The present application is a continuation of International Patent Application No. PCT/KR2024/019753, filed on Dec. 4, 2024, which is based upon and claims the benefit of priority to Korean Patent Application Nos. 10-2023-0173950 filed on Dec. 5, 2023 and 10-2024-0174475 filed Nov. 29, 2024. The disclosures of the above-listed applications are hereby incorporated by reference herein in their entirety.

### BACKGROUND

### 1. Technical Field

The present disclosure relates to an analysis and inspection automation device. More specifically, the present disclosure relates to a device for compliance requirement analysis and inspection automation and a method for controlling the same.

### 2. Description of Related Art

Recently, many companies and organizations have established global networks or branches (hereinafter collectively referred to as “global networks”), with their headquarters located in the country, providing services to customers residing overseas. However, limitations exist in responding to various information security regulations arising within these global networks. In this country, information security managers are in place to monitor changes in relevant information security regulations and establish and implement information security management systems based on these changes.

However, overseas branches, which manage global information security primarily from the headquarters, often face regulatory challenges due to differences in national legal systems, local employees' understanding of information security regulations, and limitations in information security technology. This leads to a qualitative decline in information security, which in the long term can lead to problems such as failure to comply with information security regulations and deterioration in information security.

To address these problems, global networks designate global information security managers to oversee procedures for responding to information security regulations and operating information security operations.

However, the conventional technologies have limitations, even for global information security managers, in managing regulatory changes, monitoring information security, and maintaining information security at the national level. This can lead to information security leaks.

Furthermore, the conventional technologies have addressed these issues by utilizing network equipment to conduct country-specific regulatory compliance consulting. However, even global information security regulation consulting lacks a unified information security regulation management methodology and struggles to maintain outputs such as information security regulation content and various audit data, resulting in user inconvenience.

### SUMMARY

The embodiment disclosed in the present disclosure is to provide a device for compliance requirement analysis and inspection automation that collects personal information regulations by country and automatically classifies and relearns policy tags.

The embodiment disclosed in the present disclosure is to provide a device for compliance requirement analysis and inspection automation that analyzes a company's terms and conditions and processing policies, classifies security requirements into personal information lifecycle and security control items, and displays them on a screen.

The embodiment disclosed in the present disclosure is to provide a device for compliance requirement analysis and inspection automation that automatically verifies compliance and manages risk assessments and risk response status based on the check results.

Technical problems of the inventive concept are not limited to the technical problems mentioned above, and other technical problems not mentioned will be clearly understood by those skilled in the art from the following description.

In an aspect of the present disclosure, a device for compliance requirement analysis and inspection automation may include an input module configured to collect regulatory data on personal information by country; an external device including a mobile device, and a communication module configured to transmit and receive the regulatory data; a memory configured to store at least one process for performing a compliance requirement analysis and inspection automation operation and storing input and data from a compliance manager; and a processor configured to perform an operation according to the process, wherein the processor is configured to: classify and relearn a policy tag based on the regulatory data collected through the input module, analyze at least one of a company's contract, a term and condition, a policy, a guideline, or a personal information processing policy included in the regulatory data to classify the company's security requirement into a personal information lifecycle and a security control item, verify compliance with the security requirement; and manage risk assessment and risk management based on the verified result.

Furthermore, the processor may be configured to: perform at least one of crawling, upload, link registration, and input of the regulatory data, derive a key keyword for each provision of the regulatory data, and assign a tag for personal information regulation, and calculate a similarity of the tag content.

Furthermore, the processor may be configured to: based on an update occurring to the regulatory data, assign a tag to the updated regulatory data, and calculate a similarity between the updated provision in the updated regulatory data and an existing provision.

Furthermore, the processor may be configured to: investigate a personal information protection regulation by country, and classify the investigated personal information protection regulation into a micro-regulation or common regulation.

Furthermore, the processor may be configured to: map the security requirement with a result value of a previously analyzed security risk, compare the result value with a reference value of the security requirement, based on the result value being greater than or equal to the reference value, classify the compliance as being met or requiring verification, based on the result value being less than the reference value, classify the compliance as not being met or requiring verification.

Furthermore, the processor may be configured to: based on the result value being requiring verification, calculate the result value by mapping the result value of another module or receive an input value from the compliance manager.

Furthermore, the processor may be configured to: map the security requirement with a result value of a previously analyzed security risk, and calculate a risk level based on the mapped result, wherein the risk level includes at least one of a possibility of fine, a risk of regulatory violation, or a risk of personal information leakage.

Furthermore, the processor may be configured to: receive a person responsible for performing a risk action corresponding to the risk level, a deadline, a priority, and a risk level, and transmit a message including a risk action detail to a device of the compliance manager.

Furthermore, the processor may be configured to: wherein the processor is configured to manage the risk level by changing a status to risk action completed based on a risk action trigger occurring.

Furthermore, in another aspect of the present disclosure, a method for compliance requirement analysis and inspection automation, performed by a processor of a device may include collecting regulatory data on personal information by country; classifying and relearning a policy tag based on the collected regulatory data; analyzing at least one of a company's contract, a term and condition, a policy, a guideline, or a personal information processing policy included in the regulatory data to classify the company's security requirement into a personal information lifecycle and a security control item; verifying compliance with the security requirement; and managing risk assessment and risk management based on the verified result.

In addition, a computer program stored in a computer-readable recording medium for implementing the present disclosure may be further provided.

In addition, a computer-readable recording medium recording a computer program for implementing the present disclosure may be further provided.

### BRIEF DESCRIPTION OF THE FIGURES

FIG. 1 is a configuration diagram of the entire system according to the present disclosure.

FIG. 2 is a diagram illustrating a compliance collection and registration part according to the present disclosure.

FIG. 3 is a diagram illustrating a compliance collection automation module according to the present disclosure.

FIG. 4 is a diagram illustrating a compliance inspect module according to the present disclosure.

FIG. 5 is a diagram illustrating an internal compliance inspect automation module according to the present disclosure.

FIG. 6 is a diagram illustrating a company-specific security requirement analysis automation module according to the present disclosure.

FIG. 7 is a diagram illustrating a personal information collection, use, and analysis part according to the present disclosure.

FIG. 8 is a diagram illustrating a collection form generation and response automation module according to the present disclosure.

FIGS. 9A-9C are diagrams illustrating a personal information collection form generation module according to the present disclosure.

FIG. 10 is a diagram illustrating a personal information collection detection automation module according to the present disclosure.

FIG. 11 is a diagram illustrating an automatic generation module for a collection and use consent form according to the present disclosure.

FIG. 12 is a diagram illustrating a personal information processing policy automated generation module according to the present disclosure.

FIG. 13 is a diagram illustrating a personal information subject token and consent history hash generation module according to the present disclosure.

FIG. 14 is a diagram illustrating a compliance and security risk analysis part according to the present disclosure.

FIG. 15 is a diagram illustrating a service-specific personal information analysis part according to the present disclosure.

FIG. 16 is a diagram illustrating a personal information destruction part according to the present disclosure.

FIG. 17 is a diagram illustrating an authentication management part according to the present disclosure.

FIG. 18 illustrates a status of trustees according to the present disclosure.

FIG. 19 illustrates a status of personal information processing according to the present disclosure.

FIG. 20 illustrates a status of sub-trustees according to the present disclosure.

FIG. 21 is a diagram illustrating inspection items of the inspection checklist according to this disclosure.

FIG. 22 is a diagram illustrating an inspection status of an inspection checklist according to the present disclosure.

FIG. 23 is a diagram illustrating penalty provisions of the inspection checklist according to the present disclosure.

FIG. 24 is a diagram illustrating a configuration of a compliance requirement analysis and inspection automation device according to the present disclosure.

FIG. 25 is a diagram illustrating a flowchart of a method for compliance requirement analysis and inspection automation.

FIG. 26 is a diagram illustrating a core concept of the present disclosure according to the present disclosure.

FIG. 27 is a diagram illustrating an embodiment of deriving key keywords for each clause according to the present disclosure.

FIG. 28 is a diagram illustrating an embodiment of verifying compliance with security requirements according to the present disclosure.

FIG. 29 is a diagram illustrating an embodiment of calculating risk and executing risk measures according to the present disclosure.

FIG. 30 is a diagram illustrating an embodiment that describes a problem in the prior art according to the present disclosure.

FIG. 31 is a diagram illustrating an embodiment of the processing policy simple review function according to the present disclosure.

FIG. 32 is a flowchart illustrating a simple processing policy review method according to the present disclosure.

### DETAILED DESCRIPTION

In the drawings, the same reference numeral refers to the same element. This disclosure does not describe all elements of embodiments, and general contents in the technical field to which the present disclosure belongs or repeated contents of the embodiments will be omitted. The terms, such as “unit, module, member, and block” may be embodied as hardware or software, and a plurality of “units, modules, members, and blocks” may be implemented as one element, or a unit, a module, a member, or a block may include a plurality of elements.

Throughout this specification, when a part is referred to as being “connected” to another part, this includes “direct connection” and “indirect connection”, and the indirect connection may include connection via a wireless communication network.

Furthermore, when a certain part “includes” a certain element, other elements are not excluded unless explicitly described otherwise, and other elements may in fact be included.

In the entire specification of the present disclosure, when any member is located “on” another member, this includes a case in which still another member is present between both members as well as a case in which one member is in contact with another member.

The terms “first,” “second,” and the like are just to distinguish an element from any other element, and elements are not limited by the terms.

The singular form of the elements may be understood into the plural form unless otherwise specifically stated in the context.

Identification codes in each operation are used not for describing the order of the operations but for convenience of description, and the operations may be implemented differently from the order described unless there is a specific order explicitly described in the context.

The operating principle and embodiments of the present disclosure are described below with reference to the attached drawings.

In this specification, the present disclosure may be implemented by various devices that can perform computational processing and provide results to the user. For example, the device may include all of a computer, a server device, and a portable terminal, or may be in the form of one of them. Here, the computer may include, for example, a notebook, a desktop, a laptop, a tablet PC, a slate PC, and the like mounted with a web browser.

The server device is a server that communicates with an external device to process information, and may include an application server, a computing server, a database server, a file server, a mail server, a proxy server, and a web server.

A portable terminal is a wireless communication device that ensures portability and mobility, and may include all kinds of handheld-based wireless communication devices such as PCS (Personal Communication System), GSM (Global System for Mobile communications), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), WiBro (Wireless Broadband Internet) terminal, a smart phone, and the like, and a wearable device such as at least one of a watch, a ring, bracelets, anklets, a necklace, glasses, contact lenses, or a head-mounted device (HMD).

The function related to artificial intelligence according to the present disclosure operates through a processor and a memory. The processor may be composed of one or more processors. At this time, the one or more processors may be a general-purpose processor such as a CPU, an AP, a DSP (Digital Signal Processor), a graphics-only processor such as a GPU, a VPU (Vision Processing Unit), or an artificial intelligence-only processor such as an NPU. The one or more processors control input data to be processed according to a predefined operation rule or artificial intelligence model stored in the memory. Alternatively, in the case that the one or more processors are artificial intelligence-only processors, the artificial intelligence-only processor may be designed as a hardware structure specialized for processing a specific artificial intelligence model.

The predefined operation rule or artificial intelligence model may be created through learning. Here, being created through learning means that a basic artificial intelligence model is learned by using a plurality of learning data by a learning algorithm, thereby creating a predefined operation rule or artificial intelligence model set to perform a desired feature (or, purpose). Such learning may be performed on the device itself in which the artificial intelligence according to the present disclosure is performed, or may be performed through a separate server and/or system. Examples of learning algorithms include supervised learning, unsupervised learning, semi-supervised learning, or reinforcement learning, but are not limited to the examples described above.

The artificial intelligence model may include a plurality of neural network layers. Each of the plurality of neural network layers has a plurality of weights, and performs neural network operations through operations between the operation results of the previous layer and the plurality of weights. The plurality of weights of the plurality of neural network layers may be optimized by the learning results of the artificial intelligence model. For example, the plurality of weights may be updated so that the loss value or cost value acquired by the artificial intelligence model is reduced or minimized during the learning process. The artificial neural network may include a deep neural network (DNN), for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), or a deep Q-network, but is not limited to the examples described above.

The processor may generate a neural network, train (or learn) a neural network, perform a calculation based on received input data, generate an information signal based on the result of the calculation, or retrain the neural network.

The neural network may include CNN (Convolutional Neural Network), RNN (Recurrent Neural Network), percept, multilayer perceptron, FF (Feed Forward), RBF (Radial Basis Network), DFF (Deep Feed Forward), LSTM (Long Short Term Memory), Gated Recurrent Unit (GRU), Auto Encoder (AE), Variational Auto Encoder (VAE), Denoising Auto Encoder (DAE), Sparse Auto Encoder (SAE), Markov Chain (MC), Hopfield Network (HN), Boltzmann Machine (BM), Restricted Boltzmann Machine (RBM), Depp Belief Network (DBN), Deep Convolutional Network (DCN), Deconvolutional Network (DN), Deep Convolutional Inverse Graphics Network (DCIGN), Generative Adversarial Network (GAN), Liquid State Machine (LSM), Extreme Learning Machine (ELM), Echo State Network (ESN), Deep Residual Network (DRN), Differentiable Neural Computer (DNC), Neural Turning Machine (NTM), Capsule Network (CN), Kohonen Network (KN), and Attention Network (AN), but not limited thereto, and it will be understood by those skilled in the art that any neural network may be included.

According to an exemplary embodiment of the present disclosure, the processor may use various artificial intelligence structures and algorithms such as CNN (Convolution Neural Network), R-CNN (Region with Convolution Neural Network), RPN (Region Proposal Network), RNN

(Recurrent Neural Network), S-DNN (Stacking-based deep Neural Network), S-SDNN (State-Space Dynamic Neural Network), Deconvolution Network, DBN (Deep Belief Network), RBM (Restricted Boltzmann Machine), Fully Convolutional Network, LSTM (Long Short-Term Memory) Network, Classification Network, Generative Modeling, explainable AI, Continual AI, Representation Learning, and AI for Material Design such as GoogleNet, AlexNet, VGG Network, BERT, SP-BERT, MRC/QA, Text Analysis, Dialog System, GPT-3, and GPT-4 for natural language processing, Visual Analytics, Visual Understanding, Video Synthesis for vision processing, Anomaly Detection, Prediction, Time-Series Forecasting, Optimization, and Recommendation for algorithms ResNet for data intelligence, but not limited thereto. Hereinafter, the embodiment of the present disclosure will be described in detail.

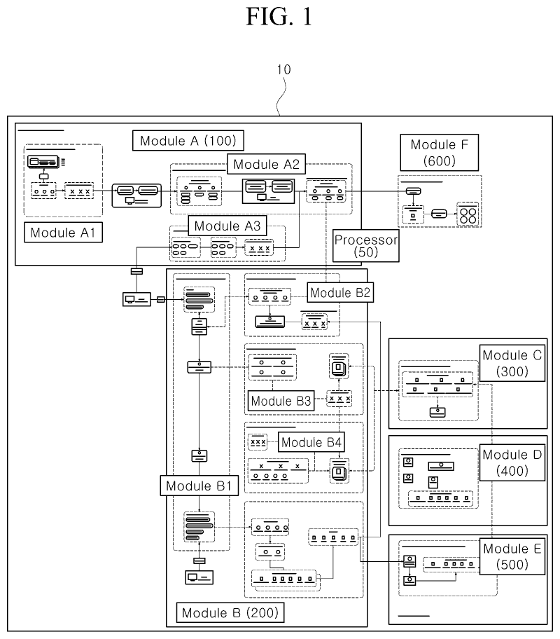

FIG. 1 is a configuration diagram of the entire system according to the present disclosure.

The overall configuration of the system will be described with reference to FIG. 1 (10).

A system 10 is briefly constructed with Module A 100, Module B 200, Module C 300, Module D 400, Module E 500, Module F 600, and a processor 50.

Module A 100 may be referred to as a compliance collection and registration part.

Module B 200 may be referred to as a personal information collection, use, and analysis part.

Module C 300 may be referred to as a compliance and security risk analysis part.

Module D 400 may be referred to as a service-specific personal information analysis part.

Module E 500 may be referred to as a personal information destruction part.

Module F 600 may be referred to as an authentication management part.

The processor 50 controls Module A 100, Module B 200, Module C 300, Module D 400, Module E 500, and Module F 600.

The detailed functions of at least one of Module A 100, Module B 200, Module C 300, Module D 400, Module E 500, or Module F 600 may be stored in a memory as software, and the processor 50 may reference the memory to execute the detailed functions of each module.

Key terms of the present disclosure are defined.

‘Compliance’ typically refers to legal compliance, compliance monitoring, and internal control. A compliance program is a set of systems designed to ensure that a company voluntarily complies with relevant laws and regulations during the business process. ‘Compliance’ includes security regulations.

‘Regulation’ includes a law, an enforcement decree, a notice, and a guideline.

‘Inspect’ refers to construction, and ‘inspection’ refers to the act of generating and organizing control items for inspection, that is, the act of establishing standards.

‘Control item’ refers to an item that an organization must comply with to protect personal information.

‘Trigger’ refers to a trigger condition.

‘Tag’ refers to a key keyword. ‘Internal compliance’ refers to an internal regulation.

‘Security requirement’ refers to a security standard and rule required by organizations (companies) or services to protect information assets.

‘Common regulation’ includes common regulations by country and industry.

‘Common regulation by country’ refers to a regulation common to the countries selected by organizations or companies.

‘Common regulation by industry’ refers to a regulation common to the industry, industry, or size selected by organizations or companies.

‘Micro-regulation’ refers to a regulation with difference among multiple regulations.

For example, the micro-regulation may be a regulation selected by an organization or company that the organization must individually comply with, or may be a regulation not specifically defined in laws or regulations, or may be a matter for which specific timing and methods are not specified.

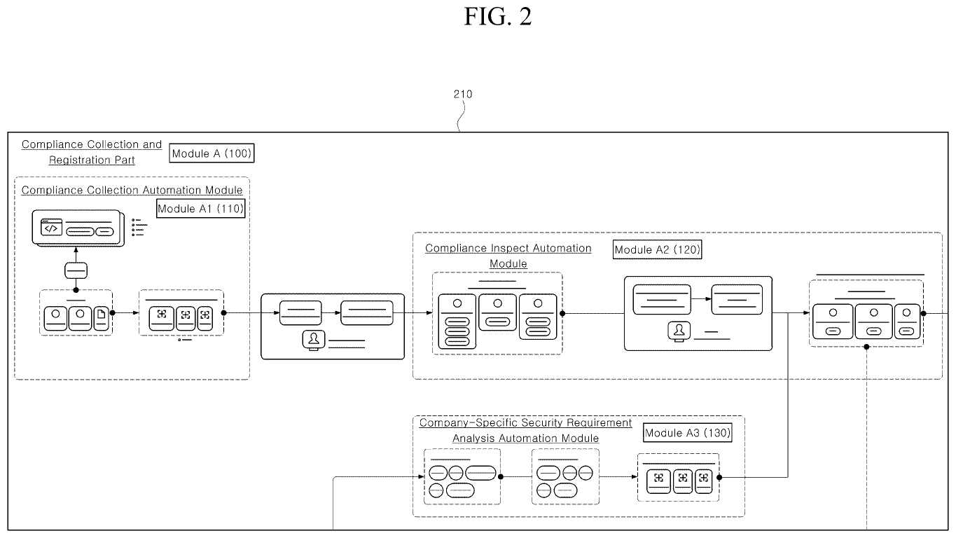

FIG. 2 is a diagram illustrating a compliance collection and registration part according to the present disclosure.

The compliance collection and registration part 100 will be described with reference to FIG. 2 (210).

The compliance collection and registration part 100 is abbreviated as Module A 100.

Module A1 110 may be referred to as the compliance collection automation module, Module A2 120 may be referred to as the compliance inspect automation module, and Module A3 may be referred to as the company-specific security requirement analysis automation module.

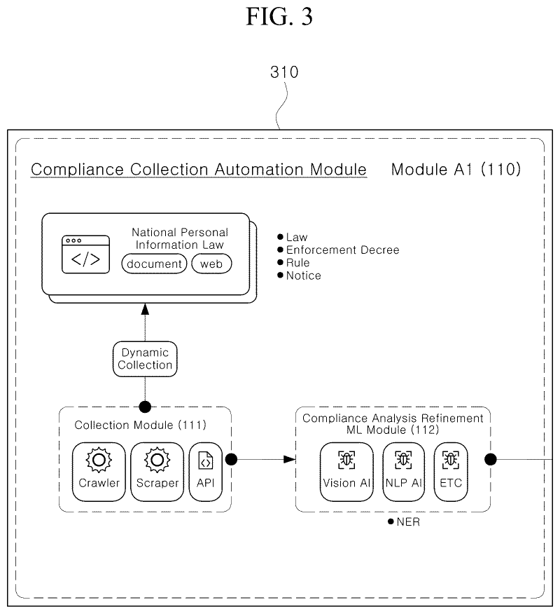

FIG. 3 is a diagram illustrating a compliance collection automation module according to the present disclosure.

Referring to FIG. 3 (310), the compliance collection automation module 110 will be described.

The compliance collection automation module 110 identifies regulations related to personal information by country, classifies regulatory provisions, and analyzes the “subject,” “object,” and “predicate” appearing in the provisions by dividing them into main text and proviso clauses.

The compliance collection automation module 110 sets keywords based on the analysis and converts them into tags.

The compliance collection automation module 110 includes a compliance collection module 111 and a compliance analysis-refinement ML module 112.

The compliance collection module 111 includes a crawler, a scraper, and API.

The compliance analysis-refinement ML module 112 sets keywords based on the analysis and converts them into tags. It includes Vision AI, NLP AI, and the like.

The compliance analysis-refinement ML module 112 performs the following:

First, the module determines priorities.

The module determines 1) whether the text is a main text or a proviso, 2) whether the regulation is a general or special law, and 3) whether the regulation is applied according to the legal system.

Second, the module determines and tags subjects, objects, and verbs.

1) Defining the “legal subject” for each provision means determining the subject of a legal provision based on the citation relationship within the legal provision.

2) Defining the “object of law” for each provision means determining the object of a legal provision based on the citation relationship within the legal provision.

3) Defining the “verb.”

Third, determining and tagging legal differences is performed.

1) Determining differences between countries regarding specific regulations (laws, enforcement decrees, enforcement rules, notices, directives, regulations, etc.).

Here, the regulation includes the following:

A law (Act, Law, Statute) is a law enacted through the legislative process of the National Assembly. In English, it is translated as “Act,” “Law,” or “Statute.” For example, “Civil Code” may be translated as “Civil Act.”

An Enforcement Decree is a presidential decree specifically enforcing a law. It is translated as “Enforcement Decree” in English.

An Enforcement Rule is a regulation of a ministry that further details an Enforcement Decree. It is translated as “Enforcement Rule.”

A Public Notice Notification is issued to announce specific matters and is translated as “Public Notice” or “Notification.”

A Directive or Instruction is an administrative order issued by a higher-level agency to a lower-level agency, and is translated as “Directive” or “Instruction.”

A Regulation Official Instruction contains regulations regarding procedures or tasks within an administrative agency and may be translated as “Regulation” or “Official Instruction.”

A country-specific personal information law (law, enforcement decree, rule, notice, directive, and regulations) management module (not shown) is processed to enable rapid assessment of a country-specific personal information-related regulation.

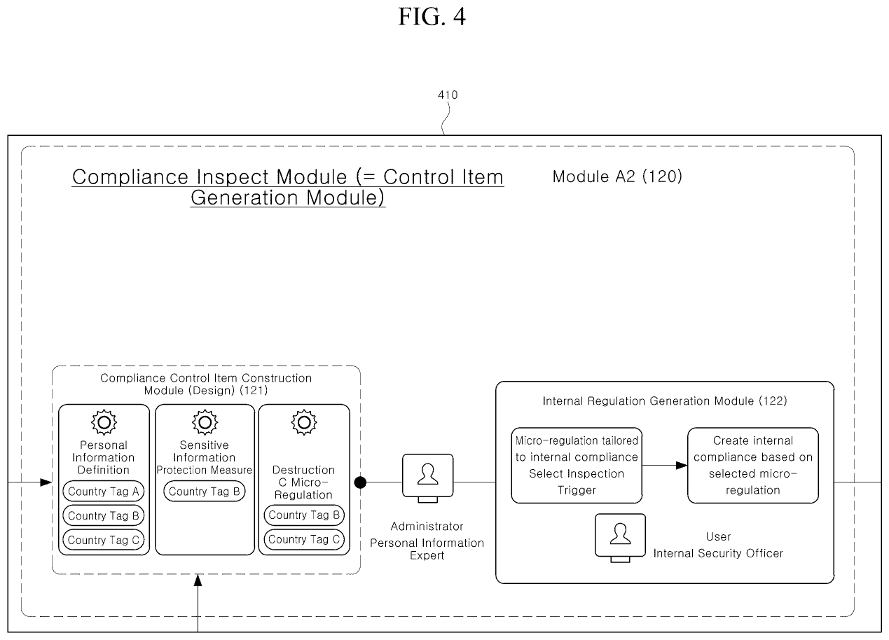

FIG. 4 is a diagram illustrating a compliance inspect module according to the present disclosure.

A compliance inspect module 120 will be described with reference to FIG. 4 (410).

The compliance inspect module 120 custom-builds and generates control items related to personal information protection that an organization must comply with.

The compliance inspect module 120 generates control items by considering 1) the “country-specific compliance” data collected and refined in Module A1 110 and 2) security requirements.

The compliance inspect module 120 includes a country-specific compliance inspection trigger automation module 121 and an internal regulation generation module 122.

The country-specific compliance inspection trigger automation module 121 examines personal information protection regulations compliance by country by attaching an appropriate tag to each provision and determines whether the examined regulation tags are micro-regulations or common regulations.

The internal regulation generation module 122 selects micro-regulations appropriate for internal compliance and generates internal regulations based on the selected micro-regulations.

The internal regulation generation module 122 allows an internal security officer to review the values from the primary module, select micro-regulations appropriate for internal regulations, and generate internal regulations based on the selected regulations.

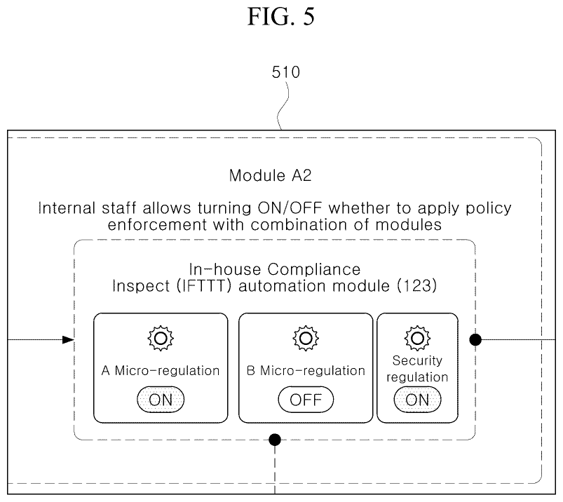

FIG. 5 is a diagram illustrating an internal compliance inspect automation module according to the present disclosure.

Referring to FIG. 5 (510), an internal compliance inspect automation module 123 is described.

The internal compliance inspect automation module 123 converts internal regulations into an inspect automation module (into inspection items) and enables inspections to be turned on or off.

The internal compliance inspect automation module 123 may be connected to Module B2 220.

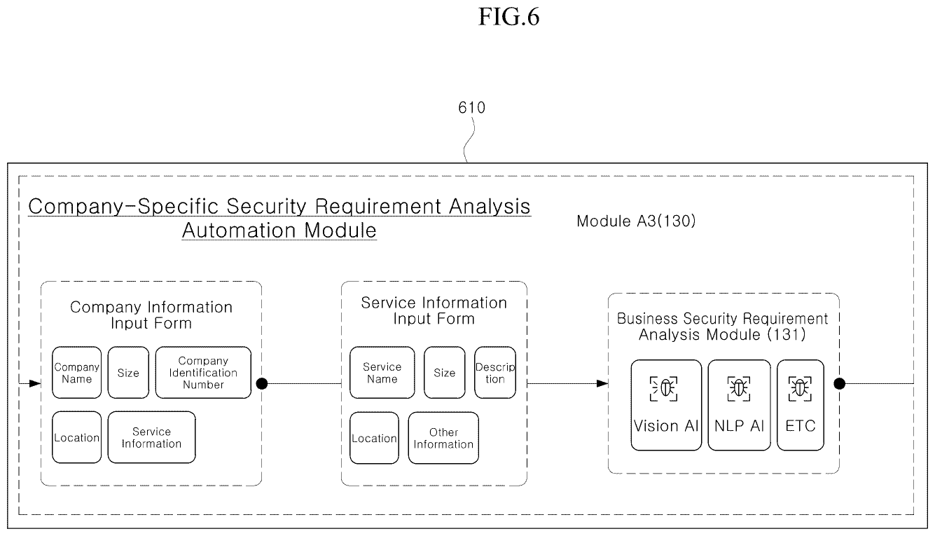

FIG. 6 is a diagram illustrating a company-specific security requirement analysis automation module according to the present disclosure.

Referring to FIG. 6 (610), a company-specific security requirement analysis automation module 130 will be described.

The company-specific security requirement analysis automation module 130 includes a business security requirement analysis module 131. Here, the company also includes an organization.

The company-specific security requirement analysis automation module 130 obtains organization information and service information.

The module obtains country information from the location, and company name, size, company identification number, and service information.

The business security requirement analysis module 131 determines which regulations apply based on the obtained information.

Specifically, the business security requirement analysis module 131 determines which regulations apply based on the obtained organization/service information.

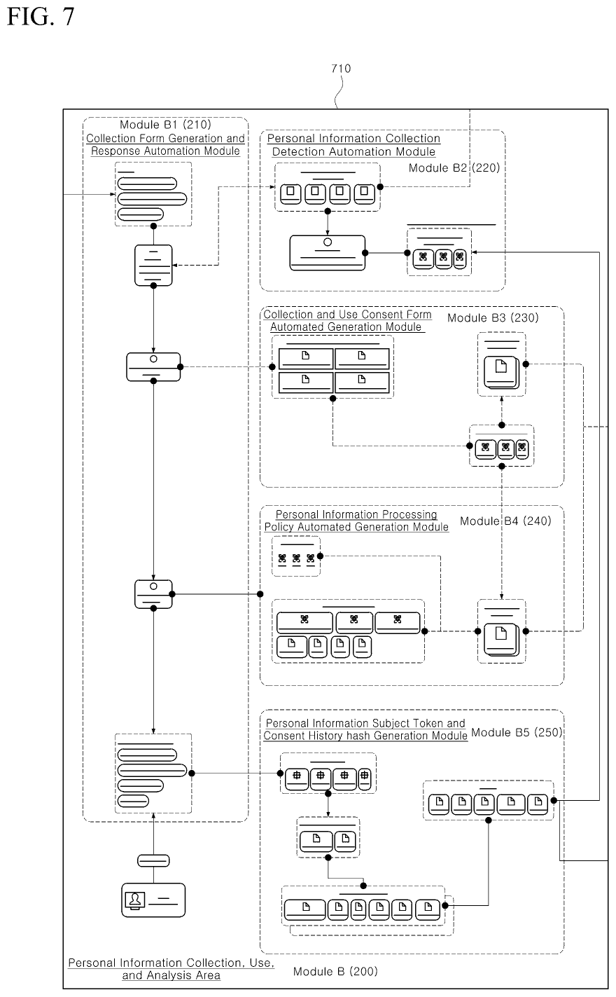

FIG. 7 is a diagram illustrating a personal information collection, use, and analysis part according to the present disclosure.

Referring to FIG. 7 (710), a personal information collection, use, and analysis part 200 will be described.

The personal information collection, use, and analysis part 200 corresponds to Module B 200.

Module B 200 includes Module B1 210, Module B2 220, Module B3 230, Module B4 240, and Module B5 250.

Module B1 210 may be referred to as a collection form generation and response automation module, Module B2 220 may be referred to as a personal information collection detection automation module, Module B3 230 may be referred to as a collection and use consent form automated generation module, Module B4 240 may be referred to as a personal information processing policy automated generation module, and Module B5 250 may be referred to as a personal information subject token and consent history hash generation module.

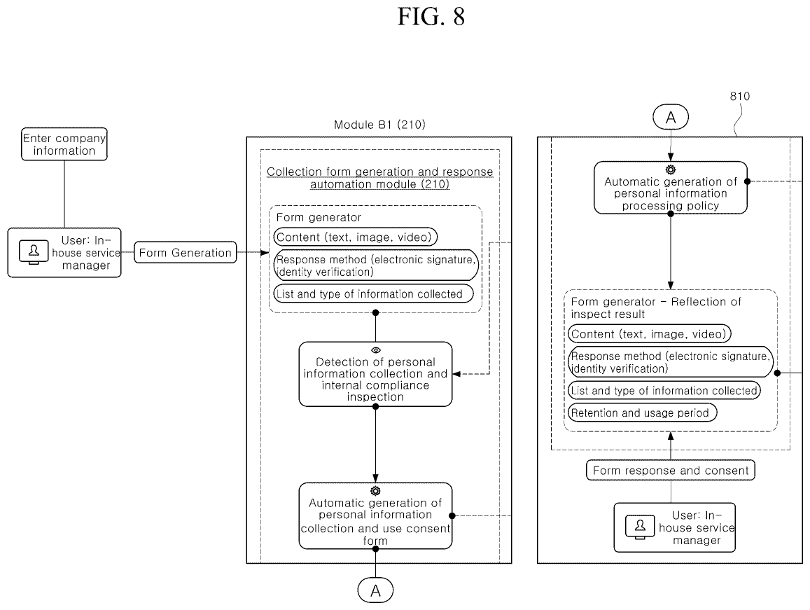

FIG. 8 is a diagram illustrating a collection form generation and response automation module according to the present disclosure.

A collection form generation and response automation module 210 will be described with reference to FIG. 8 (810).

The collection form generation and response automation module 210 allows an administrator to generate an input form and collect personal information from a data subject.

The collection form generation and response automation module 210 includes a personal information collection form generation module 211, a personal information collection detection module 212, an internal compliance implementation module 213, a processing basis generation module 214, and a personal information processing policy generation module 215.

The personal information collection form generation module 211 collects a content (text, image, or video), determines a response method (electronic signature, identity verification), and generates a list and type of information to be collected.

The personal information collection detection module 212 determines whether the personal information collected in the personal information collection form is actually personal information. In the case that the collected information is personal information, it transmits the information to the “Collection Behavior Management Department,” which is responsible for the personal information collection detection.

The internal compliance implementation module 213 investigates internal compliance.

The internal compliance implementation module 213 determines whether internal regulations are violated based on corporate and service information. That is, the inspect is performed since inspection is conducted.

The processing basis generation module 214 automatically generates a personal information collection and use consent form.

The processing basis generation module 214 automatically generates a personal information collection/provision consent form, a consent form for use, or a basis for processing. Because the consent form is generated based on institutional and service information, the consent form may be customized. The consent form may be modified, such as by tailoring it based on the information of the data subject providing the personal information.

The processing basis is as follows:

1. When a consent has been obtained from the data subject.

2. When special provisions are stipulated in the law or when it is unavoidable to comply with legal obligations.

3. When it is unavoidable for a public institution to perform its duties as prescribed by laws and regulations.

4. When it is necessary to fulfill a contract with the data subject or to take measures at the data subject's request during the contract execution process.

5. When it is clearly deemed necessary to protect the imminent life, body, or property interests of the data subject or a third party.

6. When it is necessary to achieve the legitimate interests of the personal information processor, which clearly take precedence over the rights of the data subject. This only applies when it is significantly related to the personal information processor's legitimate interests and does not exceed a reasonable scope.

7. When it is necessary for public safety and well-being, such as public health.

The personal information processing policy generation module 215 automatically generates a personal information processing policy.

The personal information processing policy generation module 215 automatically generates a personal information processing policy based on institutional and service information, and may create a customized personal information processing policy based on information from the information subject providing the personal information. The generated personal information processing policy is transmitted to the “Processing Policy Management Department” for management.

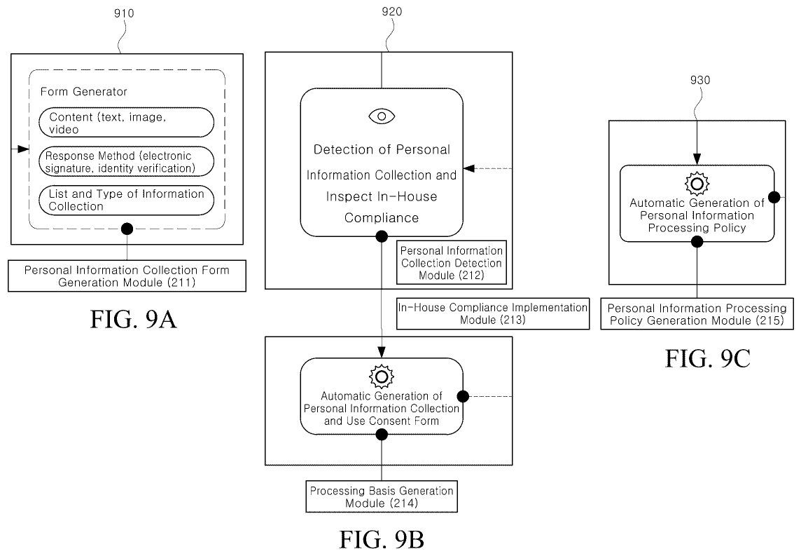

FIG. 9 is a diagram illustrating a personal information collection form generation module according to the present disclosure.

FIG. 9 includes FIG. 9(a), FIG. 9(b), and FIG. 9(c).

FIG. 9(a) (910) is a diagram illustrating the personal information collection form generation module 211.

FIG. 9(b) (920) is a diagram illustrating the personal information collection detection module 212, the internal compliance implementation module 213, and the processing basis generation module 214.

FIG. 9(c) (930) is a diagram illustrating the personal information processing policy generation module 215.

As illustrated in FIG. 9(a) (910), the personal information collection form generation module 211 generates a form for collecting personal information. The form may be selected by the internal service manager based on organization and service information, and automatically generates a personal information collection form (S1).

As illustrated in FIG. 9(b) (920), the personal information collection detection module 212 determines whether the information collected in the personal information collection form is personal information or not. In the case that the collected information is personal information, it transmits the information to the “Collection Behavior Management Department,” which is responsible for personal information collection detection (S2).

The internal compliance implementation module 213 determines whether the collected information violates the organization's internal regulations based on corporate and service information. That is, the inspect is performed since inspection is conducted (S3).

The processing basis generation module 214 automatically generates a consent form for the collection/provision of personal information or a basis for processing (S4). Because the consent form is generated based on institutional and service information, it may be customized. It may be modified, such as tailored to the information of the data subject providing the personal information. The processing basis is as follows:

1. When a consent has been obtained from the data subject.

2. When special provisions are stipulated in the law or when it is unavoidable to comply with legal obligations.

3. When it is unavoidable for a public institution to perform its duties as prescribed by laws and regulations.

4. When it is necessary to fulfill a contract with the data subject or to take measures at the data subject's request during the contract execution process.

5. When it is clearly deemed necessary to protect the imminent life, body, or property interests of the data subject or a third party.

6. When it is necessary to achieve the legitimate interests of the personal information processor, which clearly take precedence over the rights of the data subject. This only applies when it is significantly related to the personal information processor's legitimate interests and does not exceed a reasonable scope.

7. When it is necessary for public safety and well-being, such as public health.

As illustrated in FIG. 9(c) (930), the personal information processing policy generation module 215 automatically generates a personal information processing policy based on institutional information and service information, and transfers it to the “Processing Policy Management Department” for management (S5).

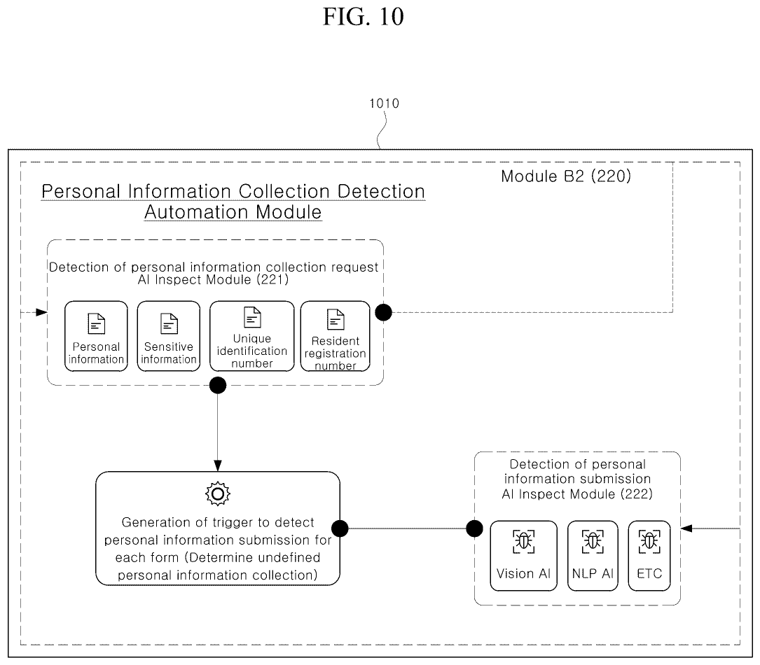

FIG. 10 is a diagram illustrating a personal information collection detection automation module according to the present disclosure.

Referring to FIG. 10 (1010), a personal information collection detection automation module 220 includes an AI inspection module 221 for detecting whether a personal information collection has been requested, and an AI inspection module 222 for detecting whether personal information has been submitted.

The personal information collection detection automation module 220 is linked to the personal information collection detection module 212 of Module B1 210.

The personal information collection detection automation module 220 is linked to the internal compliance inspect automation module 123.

The personal information collection detection automation module 220 detects whether a personal information collection request has occurred and determines whether the collected information actually corresponds to personal information, and manages it accordingly. The personal information includes sensitive information, unique identification numbers, and resident registration numbers.

The AI inspect module 221 for detecting whether a personal information collection automatically classifies the type of information collected (e.g., personal information, sensitive information, unique identification numbers, etc.) according to the type of personal information collected and automatically applies appropriate processing procedures for each type.

The AI inspect module 222 for detecting whether personal information has been submitted detects whether personal information has been submitted. To prevent unwanted, unnecessary, or unintended collection of personal information, it determines whether user-provided information constitutes personal information through AI-based analysis (e.g., Vision AI, NLP AI, etc.) and detects whether such information has been collected.

The AI inspect module 222 for detecting whether personal information has been submitted analyzes user input data using various artificial intelligence technologies, such as Vision AI and NLP AI, and determines in real time whether the input information constitutes personal information.

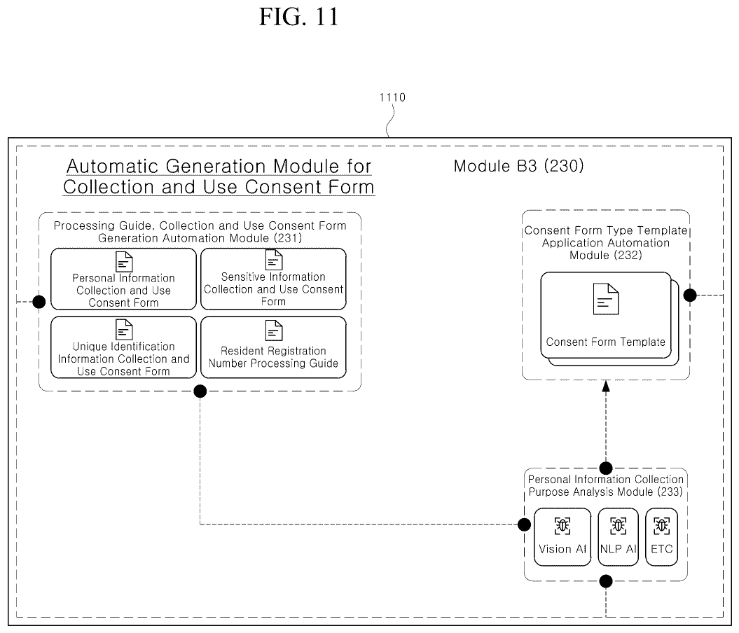

FIG. 11 is a diagram illustrating an automatic generation module for a collection and use consent form according to the present disclosure.

An automatic generation module for a collection and use consent form 230 will be described with reference to FIG. 11 (1110).

An automatic generation module for a collection and use consent form 230 corresponds to Module B3 230.

The automatic generation module for collection and use consent form 230 includes a processing guide, collection and use consent form generation automation module 231, a consent form type template application automation module 232, and a personal information collection purpose analysis module 233.

The automatic generation module for collection and use consent form 230 is a system that automatically generates and manages consent forms required during the collection and processing of personal information. The module analyzes the type and purpose of personal information collection and automatically applies an appropriate consent form template, and automates the process of obtaining consent from the data subject by generating a customized consent form that reflects legal requirements, thereby complying with personal information protection regulations.

The operational flow of the present disclosure will be described.

First, the type of personal information consent form is selected based on the type of personal information classified by Module B2 220.

Second, the information to be included in the consent form is directly entered by the personal information processor.

1. If the purpose of processing personal information falls under the conditions that do not require a consent form, a consent basis is generated.

2. If a consent form is generated, the purpose of processing personal information within the consent form is proposed by the personal information collection purpose analysis module, referencing the values in the personal information collection form generation module.

3. A consent form is generated using the above information and the template selected by the personal information processor.

The processing guide, collection and use consent form generation automation module 231 automatically generates consent forms and processing guides related to personal information, sensitive information, and uniquely identifiable information. Consent forms and guides are categorized into the following formats:

1) A personal information collection and use consent form is generated when general personal information (name, phone number, email, etc.) is collected. It includes the collection items, purpose, retention period, right to refuse consent, and any disadvantages thereof.

2) The consent form for the collection and use of sensitive information is used when collecting sensitive personal information, such as health or financial information, and includes notices and requests for additional consent in accordance with relevant laws.

3) The consent form for the collection and use of unique identification information is generated when collecting unique identification numbers, such as alien registration numbers, passport numbers, and driver's license numbers, and includes notices and requests for additional consent in accordance with relevant laws.

4) The resident registration number processing guide is provided when processing unique identification numbers, such as resident registration numbers, and clearly states the purpose and legal basis for processing.

5) The optional consent form is generated when collecting personal information selectively, rather than for essential purposes such as advertising. It includes information on the collected items, purpose, retention period, right to refuse consent, and any disadvantages associated with such collection.

The processing guide, collection and use consent form generation automation module 231 provides an intuitive interface for data subjects to understand the consent form and easily choose whether to consent. Each item in the consent form is updated in accordance with relevant laws and regulations.

The consent form type template application automation module 232 predefines various types of consent forms and processing guide templates and automatically applies the appropriate template based on the user's selected personal information collection purpose and legal requirements. The main functions of this module are as follows:

First, consent form template management.

Different templates are provided depending on the type of personal information collected, and customized consent forms are generated based on the service purpose. For example, different templates may be applied depending on the personal information required for online service registration and offline transactions.

Second, template application rules.

These rules automatically select the appropriate template when specific information types are entered, and these rules operate based on the personal information handler's selection. For example, a sensitive information template is applied when collecting health information, and a personal information template is applied when collecting simple contact information.

Third, legal regulations are automatically reflected.

Legal regulations by country and industry are reflected in the consent form template according to predefined rules. For example, consent form content is reflected appropriately when applying the GDPR (European General Data Protection Regulation) or the CCPA (California Consumer Privacy Act).

The consent form type template application automation module 232 is continuously updated, enabling the template to immediately reflect new laws or regulations as they are announced.

The personal information collection purpose analysis module 233 utilizes Vision AI, NLP AI, and other artificial intelligence technologies to analyze user-entered information and automatically classify and process the personal information collection purpose accordingly. Key functions include:

First, Vision AI-based image analysis.

If the personal information collection form includes an image, the subject matter is extracted and analyzed from the text or image to suggest an appropriate purpose. For example, if the subject matter of an event is extracted from an event poster image, a corresponding purpose is recommended.

Second, NLP AI-based text analysis is used.

Text data entered by the user is analyzed to determine the purpose of collection. For example, information entered by the user to create an online registration page is analyzed and recommended as service subscription.

Third, consent form recommendations are provided for each purpose.

Based on the collected information, the system analyzes which legal requirements the information must meet and recommends a corresponding purpose. For example, if a resident registration number is collected on a prize winner's personal information collection form, the system recommends tax reporting purposes.

The personal information collection purpose analysis module 233 accurately analyzes the purpose of processing collected personal information and helps to notify and obtain consent from the information subject by applying an appropriate processing method in accordance with the Personal Information Protection Act.

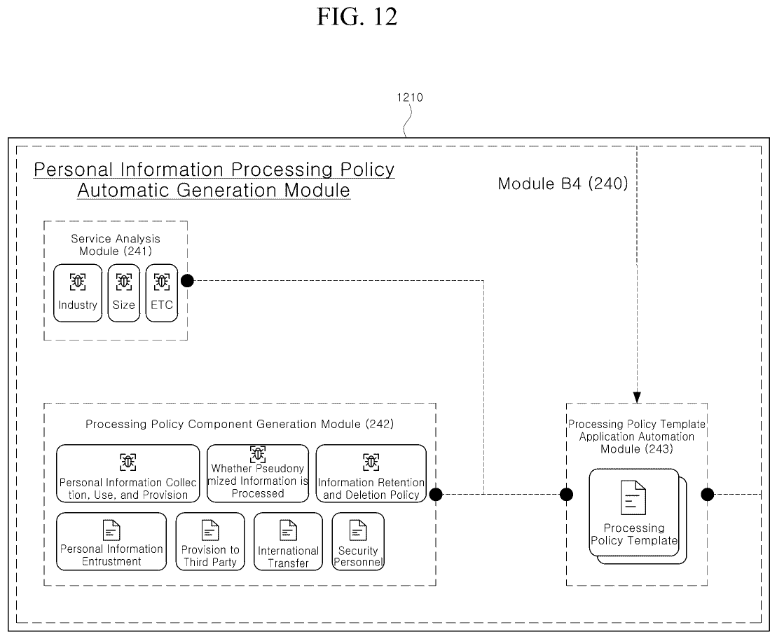

FIG. 12 is a diagram illustrating a personal information processing policy automated generation module according to the present disclosure.

Referring to FIG. 12 (1210), a personal information processing policy automated generation module 240 will be described.

The personal information processing policy automated generation module 240 corresponds to Module B4 240.

The personal information processing policy automated generation module 240 includes a service analysis module 241, a processing policy component generation module 242, and a processing policy template application automation module 243.

The personal information processing policy automated generation module 240 is a module that automatically generates and manages personal information processing policies. The module automates all procedures, from service analysis to processing policy template reflection. This module meets legal requirements related to personal information processing and is characterized by automatically generating processing policies tailored to the company's service characteristics and security requirements.

The personal information processing policy automated generation module 240 automatically generates and manages personal information processing policies. The module uses the service analysis module to identify service characteristics, automatically generates processing policy components, and incorporates these into a template to finalize the policy. This system satisfies legal requirements arising during personal information processing and effectively complies with legal regulations related to personal information protection by providing customized processing policies tailored to the characteristics of service providers.

The personal information processing policy automated generation module 240 includes three modules, each of which efficiently performs processing policy composition and automated management procedures.

The operational flow linked to other modules is described below.

First, by receiving service status information from users, processing policy requirements related to the current status, such as the relevant industry is analyzed.

Second, by receiving personal information processing status information from users, processing policy requirements related to that status is analyzed.

Third, a personal information processing policy is created based on the provided information.

Fourth, the user-selected template is applied to output the personal information processing policy.

The service analysis module 241 analyzes the service's size, industry, and security requirements to create a personal information processing policy tailored to the characteristics of the company or service provider. Its main functions are as follows:

First, industry analysis.

It analyzes the industry to which the service belongs and automatically reflects the industry's regulations and legal requirements. For example, financial services and healthcare services have different legal requirements, so it automatically identifies and generates policies tailored to each industry.

Second, service scale analysis.

The complexity and requirements of a personal information processing policy vary depending on the size of the company. This module analyzes the size of the service provider, whether it's a large corporation, a small or medium-sized enterprise, or a startup, and selects an appropriate processing policy. For large-scale services, complex data processing policies may be applied, while for small-scale services, simplified processing policies may be applied.

Third, there is other variables analysis (ETC).

This analyzes various factors, including the service provider's business model, customer scope, and whether international data transfers are involved. For example, when providing global services, legal requirements for cross-border data transfer are reflected in the processing policy.

The processing policy component generation module 242 automatically generates key components of the processing policy based on data provided by the service analysis module. This module designs each item of the processing policy in detail and may be tailored to the company's operational policies. Its main functions are as follows:

First, the collection, use, and provision of personal information.

It defines the purpose of collecting personal information, the types of information collected, and whether consent was obtained from the data subject. This includes the scope of use of the personal information collected by the company and the method of providing it to third parties, and is designed to ensure clear notification to the data subject.

Second, application of process pseudonymized information.

For companies that use pseudonymized information, the scope and processing method of pseudonymized personal information are automatically defined. This policy is tailored to the type of data requiring pseudonymization and its intended use, and legal grounds are provided where necessary.

Third, the information retention and destruction policy.

This policy defines how long collected personal information will be retained and how it will be destroyed when no longer needed. This policy automatically generates information retention periods and destruction procedures, and includes data retention and destruction policies tailored to specific legal regulations (e.g., GDPR or CCPA).

Fourth, the entrustment and third-party provision of personal information.

If personal information is entrusted to an external party or provided to a third party, all necessary legal procedures and consent forms are managed. The legal requirements for entrusting personal information and methods of sharing data with third parties are clearly defined, and consent is obtained from the data subject.

Fifth, international transfer and security personnel.

When personal information is transferred internationally, the security and legal requirements arising during the process are reflected. Furthermore, the system is designed to strengthen data protection by specifying the deployment of internal security personnel and their roles.

The processing policy template application automation module 243 reflects the generated personal information processing policy components into templates and automates the process. This module automatically maps each component to a predefined template to complete the processing policy. Key functions include:

First, processing policy template management.

Predefined templates are provided for each item in the personal information processing policy, and the templates are modified and optimized to meet the needs of the service provider. For example, financial institutions may provide templates with more stringent security requirements, while small services may provide simple processing policies.

Second, automatic template mapping.

Data generated from the service analysis module and processing policy component generation module is automatically mapped to templates. This process is performed without manual intervention, and processing policies tailored to the characteristics of each service are automatically generated.

Third, reflection of legal requirements.

Automated rules are established to ensure that legal requirements are reflected within the template. For example, if regulations such as GDPR or CCPA are included, relevant items are automatically added and content specifying the rights and responsibilities of the data subject is included.

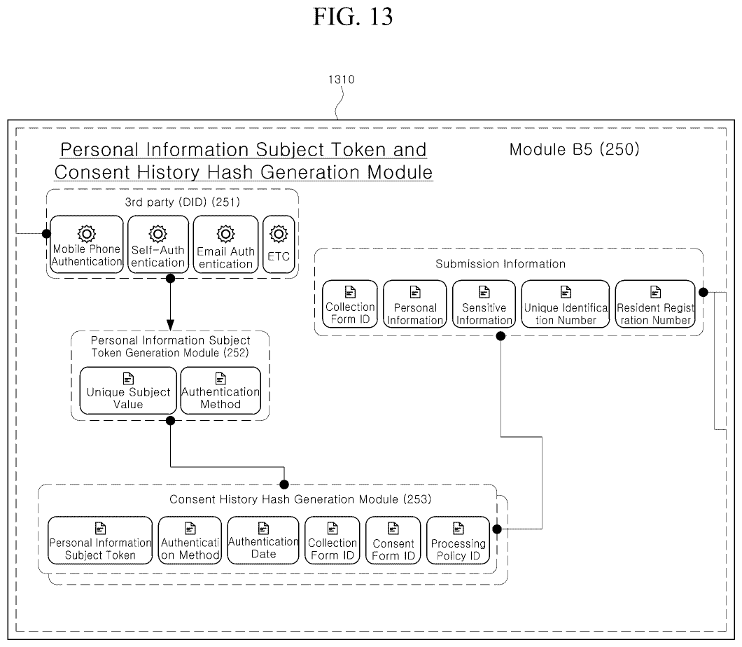

FIG. 13 is a diagram illustrating a personal information subject token and consent history hash generation module according to the present disclosure.

Referring to FIG. 13 (1310), a personal information subject token and consent history hash generation module 250 will be described.

The personal information subject token and consent history hash generation module 250 corresponds to the B5 module 250.

The personal information subject token and consent history hash generation module 250 includes a third-party DID module 251, a personal information subject token generation module 252, and a consent history hash generation module 253.

The personal information subject token and consent history hash generation module 250 generates and manages the personal information subject token and the consent history hash value in a personal information protection system. This module processes the personal information subject's authentication in various ways, securely stores data generated during the consent process, and maintains record integrity through hash values. Furthermore, it collaborates with third parties (DIDs) to provide various authentication methods and ensure information reliability.

The personal information subject token and consent history hash generation module 250 automates all procedures required for data subject token generation and consent history management. This module securely authenticates the identity of the data subject, converts consent history into a hash value to ensure integrity, and thoroughly manages submitted personal information. This module may effectively meet legal requirements related to personal information protection.

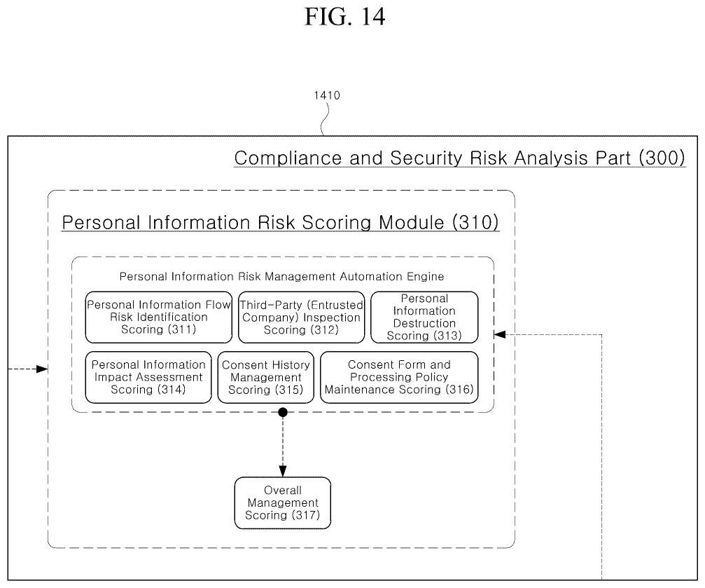

FIG. 14 is a diagram illustrating a compliance and security risk analysis part according to the present disclosure.

A compliance and security risk analysis part 300 will be described with reference to FIG. 14 (1410).

The compliance and security risk analysis part 300 includes a personal information risk scoring module 310.

The personal information risk scoring module 310 includes a personal information flow risk identification scoring module 311, a third-party (trustee) cooperation scoring module 312, a personal information destruction scoring module 313, a personal information consistency scoring module 314, a consent history management scoring module 315, a registration and processing policy maintenance management scoring module 316, and an overall integrated scoring module 317.

The compliance and security risk analysis part 300 automatically assesses the risk of personal information within the system to meet personal information protection and compliance requirements and performs a comprehensive risk assessment through various scoring methods.

The compliance and security risk analysis part 300 assesses security risks that may arise at all stages of personal information collection, processing, storage, and destruction, thereby supporting the implementation of appropriate protective measures.

The compliance and security risk analysis part 300 analyzes the risk of personal information using various scoring methods, and each scoring is performed based on the following criteria.

The operational flow linked to other modules is described.

First, each scoring function operates independently.

Second, the risk is analyzed based on the scoring results.

The personal information flow risk identification scoring module 311 assesses the risks that may arise during the process of personal information being collected and transferred within the system. Its main functions are as follows:

First, data movement path analysis.

This module tracks and analyzes where personal information is transferred within the system and how it is processed. It assesses the risk by identifying potential data leaks and unauthorized access that may occur during the information transfer process.

Second, access rights analysis.

This module analyzes the level of access rights granted to users with access to personal information and assesses whether appropriate rights have been granted. If permissions are unnecessarily broad or illegal access attempts are detected, the risk is assessed as high.

Third, data encryption status analysis.

This module verifies whether appropriate encryption is applied during the transfer of personal information. If encryption is not applied or the encryption level is low, the risk score increases.

The third-party (trustee) cooperation scoring module 312 assesses the risks that arise when personal information is shared with external trustees or third parties. It analyzes security risks that may arise when personal information is processed by trustees. Its main functions are as follows:

First, it evaluates the trustee's security level.

It evaluates the security policies and management status of the trustee processing personal information. If the trustee does not implement appropriate security measures or has not obtained security authentication, the risk level is assessed as high.

Second, it evaluates the data transmission security.

It analyzes the security protocols used when personal information is transmitted to a third party. For example, it evaluates whether data is transmitted encrypted and whether the security certificate is valid, thereby calculating the risk level.

Third, it analyzes third-party access control.

The risk increases if unnecessary access rights are granted or management is poor by analyzing the permissions and access control methods of third parties with access to personal information.

The personal information destruction scoring module 313 evaluates the process of properly destroying collected personal information when it is no longer needed or the legal retention period has expired. Its main functions are as follows:

First, it evaluates compliance with the destruction policy.

It evaluates whether the personal information destruction policy complies with relevant laws and regulations. For example, it verifies whether personal information is destroyed in a timely manner in accordance with legal requirements such as GDPR and CCPA.

Second, it evaluates the destruction method.

It assesses whether personal information has been completely deleted in an appropriate manner or if it is recoverable. If secure data deletion methods e.g., digital shredding, overwriting, and the like have not been applied, the risk is assessed as high.

Third, the transparency of the destruction procedure is assessed.

This assesses whether the destruction process is managed transparently and records are maintained. If the destruction procedure is unclear or records are incomplete, the risk increases.

The personal information consistency scoring module 314 assesses whether collected personal information is used for its original purpose and whether the collected information is accurate. Its main functions are as follows:

First, it assesses whether the collected personal information is consistent with the purpose of collection.

This analyzes whether personal information is being used for the originally agreed-upon purpose. If personal information is being used for an unauthorized purpose, the risk is assessed as high.

Second, it assesses the accuracy of personal information.

This assesses whether the collected personal information is accurate and whether incorrect information is entered. The risk increases if inaccurate information is processed or errors occur.

Third, it assesses the protection of the data subject's rights.

This module assesses whether the data subject may properly exercise their right to correct, delete, or suspend the use of their personal information. If the data subject's request is ignored or not processed, the risk is assessed as high.

The consent history management scoring module 315 assesses whether appropriate consent was obtained from the data subject when personal information was collected and whether that consent is legally managed. Its main functions are as follows:

First, it assesses compliance with consent procedures.

It assesses whether clear consent was obtained from the data subject for the collection and use of personal information. If personal information is collected or used without appropriate consent, the risk is assessed as high.

Second, it assesses the management status of consent records.

It assesses whether consent records are securely stored and whether withdrawals of consent are promptly reflected upon the data subject's request. The risk increases if consent records are damaged or withdrawal requests are not reflected.

The registration and processing policy maintenance management scoring module 316 evaluates whether the personal information processing policy is properly registered and maintained. Its main functions are as follows:

First, it evaluates the recency of the processing policy.

It evaluates whether the personal information processing policy is continuously updated to reflect the latest legal requirements. If the processing policy is not updated despite changes in legal regulations, the risk is assessed as high.

Second, it evaluates the transparency of the processing policy.

It evaluates whether the processing policy is easily accessible to the data subject and whether the policy is clear and understandable. If the processing policy is opaque or difficult for the data subject to access, the risk increases.

The overall integrated scoring module 317 synthesizes the risks generated from each individual scoring module to calculate the integrated risk of the entire personal information processing process. The overall integrated scoring includes the following elements:

First, weighting is applied.

The overall risk is calculated by applying weights based on the importance of each scoring module. For example, if the weight of the personal information destruction scoring is high, a poor destruction process may significantly impact the overall risk.

Second, the overall risk is calculated.

The final overall risk is calculated based on the individual scoring results. The overall risk indicates the overall security level of personal information processing and may be used to suggest additional security measures or management strategies.

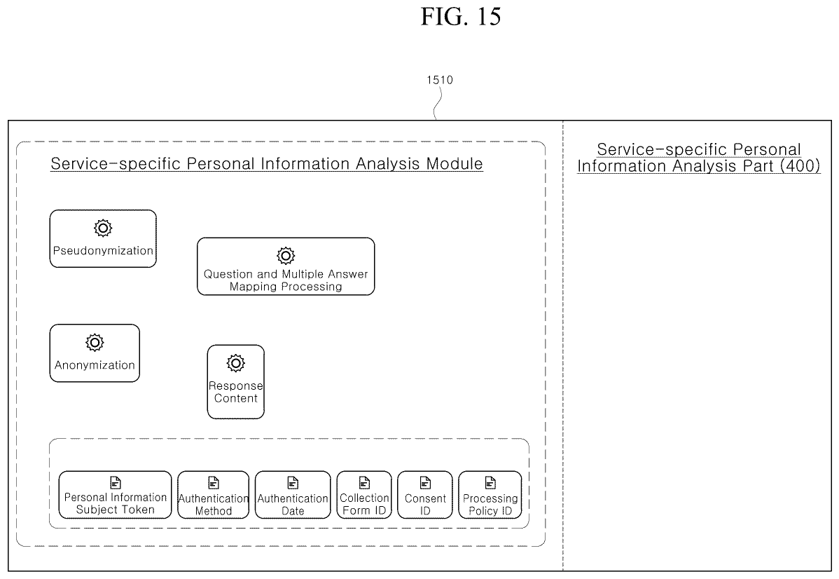

FIG. 15 is a diagram illustrating a service-specific personal information analysis part according to the present disclosure.

A service-specific personal information analysis part 400 will be described with reference to FIG. 15 (1510).

The service-specific personal information analysis part 400 includes a service-specific personal information analysis module 410.

The service-specific personal information analysis part 400 is a system that analyzes personal information collected during service provision by pseudonymizing and anonymizing it. Based on this, it classifies user-provided responses into keywords and determines whether they are positive or negative.

The service-specific personal information analysis part 400 performs pseudonymization and anonymization processing to protect personal information, and performs various stages of personal information analysis to support functions necessary for service provision. The service-specific personal information analysis part 400 of the present disclosure primarily consists of the following processing steps.

The first step is the pseudonymization step.

The pseudonymization step protects personal information provided by users by pseudonymizing elements that may directly identify a specific individual. Pseudonymization is a key method for strengthening privacy protection while using personal information for data analysis and service optimization. Its main functions are as follows:

First, it separates personal information identifiers.

Personal information provided by users, such as name, resident registration number, and email address, is replaced with the minimum information necessary for data analysis. This ensures that data is processed in a manner that prevents the identification of specific individuals.

Second, it applies a pseudonymization algorithm.

During the pseudonymization process, personal information is replaced using algorithms such as randomization or hash functions. For example, a user's name is pseudonymized by replacing it with a randomly generated ID. This ID may identify the same individual, but may not be directly traced back to the original data.

Third, it manages pseudonymized data for data analysis.

Pseudonymization processed personal information is managed for analysis purposes and stored separately from the original data. After analysis, the original data may be set to not be recovered.

The second step is anonymization.

The anonymization stage removes all personally identifiable information from personal information, processing the data in a completely anonymous state. Anonymization completely obscures an individual's identity and is primarily used in statistical analysis or large-scale data analysis. Its main functions are as follows:

First, it completely removes personally identifiable information.

It deletes or replaces all identifiable information, such as name, resident registration number, and address, from personal information, preventing the tracing of specific individuals during data analysis.

Second, it enhances statistical security.

Anonymized data is used as aggregated data, not individual information. For example, only non-identifiable information, such as the user's age or gender, is retained for statistical analysis.

Third, there are measures to prevent re-identification.

Additional security measures are applied to anonymized data to prevent re-identification. Various security technologies are applied to prevent data recombining to restore the original data.

The third step is the question and multiple answer merge process.

The question and multiple answer merge process analyzes and merges multiple user-provided answers to derive a consistent response. This process integrates multiple answers to generate final data and provides service-specific results based on that data. The main functions are as follows: First, question analysis.

The content of the user-entered question and the multiple responses it generates are analyzed. Natural language processing NLP technology is used to understand the meaning of the question and extract and process relevant answers.

Second, multiple answer merge.

When multiple answers are provided for the same question, duplicate or ambiguous answers are merged to derive a consistent answer. This improves the quality of the answer data and provides consistent results.

Third, answer optimization.

The merged answers are optimized and refined to provide optimal answers when providing services.

The fourth step is answer content analysis.

The answer content analysis step analyzes the answer data provided by the user and determines the keywords and meaning of the answer, whether positive or negative. This step utilizes natural language processing NLP technology to analyze the answers, extract key keywords, and determine the sentiment of the answers through sentiment analysis. The main functions are as follows:

First, keyword extraction.

This step extracts important keywords from user-provided answers. It identifies words that appear frequently in the text data or are contextually important and categorizes them as keywords. For example, keywords such as “satisfied,” “dissatisfied,” “fast,” and “slow” are extracted.

Second, positive and negative judgment is performed.

Based on the extracted keywords, the response is automatically classified as positive or negative. A sentiment analysis algorithm is used to determine whether the keyword carries a positive or negative connotation. For example, the keyword “satisfied” is classified as positive, while “dissatisfied” is classified as negative.

Third, keyword weighting is performed.

Weighting is assigned to the extracted keywords to determine the importance of the response in providing the service. Different weights are assigned based on importance, thereby improving the accuracy of the analysis results.

This section explains how to determine keywords, positive, and negative responses.

First, NLP-based text preprocessing is performed.

The response data is input into a natural language processing model, where unnecessary words are removed and converted into an analyzable format. This includes preprocessing tasks such as tokenization, stop-word removal, and stemming.

Second, keywords are extracted.

Important keywords are extracted based on the preprocessed data. Using techniques such as TF-IDF and Word2Vec, high-frequency and context-sensitive words are identified.

Third, sentiment analysis is performed.

Based on the extracted keywords, the sentiment of the response is analyzed and classified into positive, negative, and neutral meanings. The sentiment analysis algorithm uses a pre-trained dictionary of positive and negative words to evaluate the sentiment of each keyword.

Fourth, the results are generated.

Finally, the extracted keywords are combined with the sentiment analysis results to derive the meaning of the response and generate the information necessary for service provision.

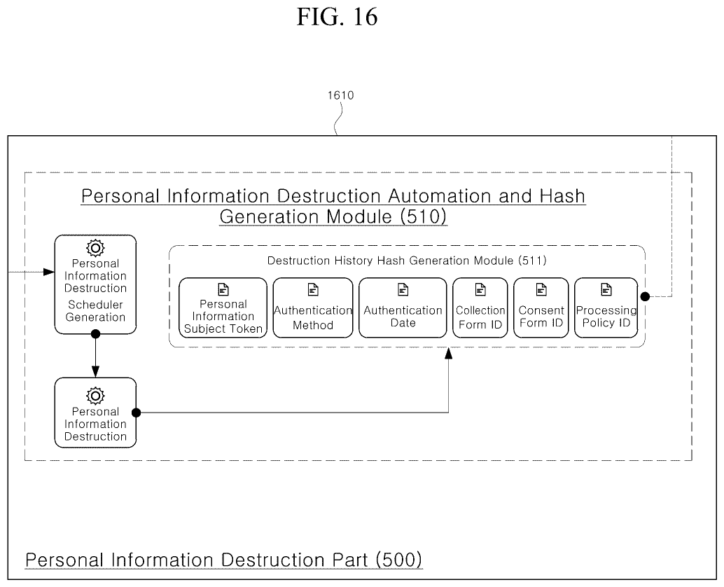

FIG. 16 is a diagram illustrating a personal information destruction part according to the present disclosure.

Referring to FIG. 16 (1610), the personal information destruction part 500 will be described.

The personal information destruction part 500 includes a personal information destruction automation and hash generation module 510.

The personal information destruction automation and hash generation module 510 includes a destruction history hash generation module 511.

The personal information destruction part 500 is a system that securely destroys personal information when the collection and storage period of the information ends, and generates a hash value for the destruction history generated during the process to ensure its integrity.

The personal information destruction part 500 automates the personal information destruction process, ensuring compliance with legal requirements and transparently managing the data destruction process. The personal information destruction part 500 destroys personal information through the following main steps.

The first step is generation a personal information destruction Scheduler.

This step automatically creates and executes a destruction schedule when personal information no longer needs to be retained. This applies when the personal information retention period has expired or immediate destruction is required at the data subject's request. The main functions are as follows:

First, reviewing the retention period.

The retention period for each personal information item is reviewed and checked to see if the retention period set by legal or service requirements has been exceeded. Personal information is reviewed based on the preset retention period, and any data exceeding the retention period is designated for destruction.

Second, automatic setting of the destruction schedule.

Once personal information is designated for destruction, a destruction scheduler is automatically created and a destruction schedule is set. The destruction schedule may be adjusted to optimize time, taking into account legal requirements and system resources.

Third, immediate destruction request processing.

If the data subject requests immediate destruction of personal information, the scheduler immediately sets a destruction schedule and quickly executes the data destruction process.

The second step is the personal information destruction stage.

The personal information destruction stage is the process of actually destroying personal information according to the schedule set by the scheduler. This stage securely destroys data through physical or logical means, and the destroyed information is processed so that it may not be recovered. Its main functions are as follows:

First, logical destruction.

This stage destroys personal information stored within the system by deleting it. This process removes the personal information from files or databases, making it no longer accessible or retrievable. Logical destruction is performed by removing all indexes and references to the relevant data within the system.

Second, physical destruction.

This method completely destroys data by shredding or deleting disks or other storage media containing personal information stored on physical storage devices. This method physically destroys the disk or media, rendering the data unrecoverable.

Third, data overwriting.

To ensure that logically deleted data may not be recovered, the data storage space is repeatedly overwritten with random data to confirm destruction. This process is a secure method for completely erasing digital data, preventing the possibility of recovery.

The third step is the destruction history hash generation step.

The destruction history hash generation step records the history of personal information destruction and generates a hash value to ensure its integrity. This step records information about the destroyed personal information and the destruction process, and generates a hash value to prevent tampering with this information. The main functions are as follows:

First, destruction history data is collected.

After personal information is destroyed, all data generated during the destruction process is collected. This includes information such as the personal information subject token, authentication method, authentication date, collection form ID, consent ID, and processing policy ID. This data is a critical element in ensuring the reliability of the destruction history.

Second, hash value generation.

Based on the collected destruction history data, a hash algorithm such as SHA256 is applied to generate a unique hash value. The hash value ensures the integrity of the destruction history and protects the data from tampering during the subsequent verification process.

Third, the destruction history is stored and managed.

The generated hash value is securely stored along with the history of destroyed personal information, and is managed so that its integrity may be verified by a authentication authority or audit process. The log and hash value of the destroyed data are protected from external access and may be referenced for data verification when necessary.

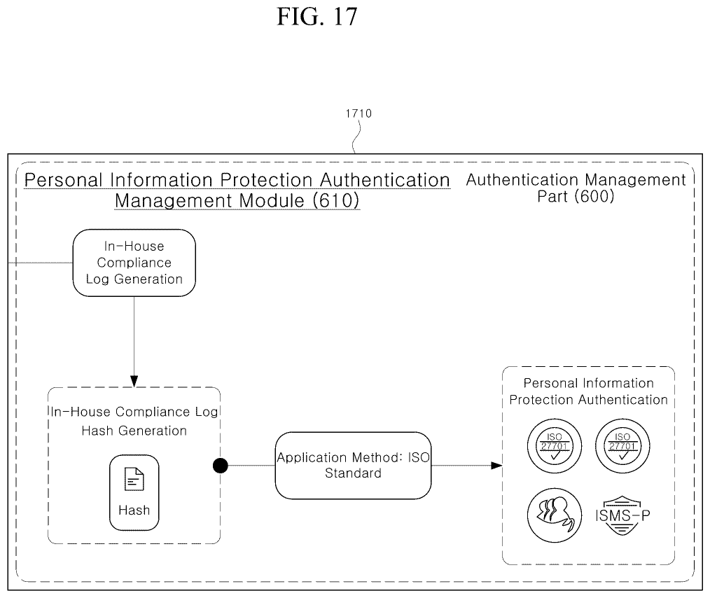

FIG. 17 is a diagram illustrating an authentication management part according to the present disclosure.

The authentication management part 600 will be described with reference to FIG. 17 (1710).

The authentication management part 600 includes a personal information protection authentication management module 610.

The authentication management part 600 is a system that manages and maintains authentications related to personal information protection. It acquires and maintains various international and domestic standard authentications based on compliance logs generated within the company.

The authentication management part 600 includes steps for safely processing data generated during the authentication process and verifying compliance with authentication standards. The authentication management part 600 of the present disclosure primarily manages authentication through the following steps:

The first step is internal compliance log generation.

This step records all activities occurring within the system to ensure compliance with personal information protection and related legal regulations. This log contains data related to personal information processing, access control, and security incident response, and primarily collects and stores the following information:

First, personal information processing activity records.

All activities, such as the collection, storage, processing, and destruction of personal information, are recorded in the internal compliance log. Each record includes the time of the activity, the person in charge, and related information.

Second, the access control log.

Prevents illegal access or abuse of authority by recording users who accessed personal information, their permission levels, and the time of access.

Third, security incident response records are provided.

If a security incident involving personal information occurs, the response details are recorded. For example, this includes incident response records for hacking attempts or internal information leaks.

The logs collected in this step are used as data required for subsequent authentication applications, ensuring a transparent record of all personal information processing activities occurring within the company.

The second step is the internal compliance log hash generation step.

The internal compliance log hash generation step generates a hash value to ensure the integrity of the collected compliance log data. The hash value plays a crucial role in protecting data and verifying whether the log has been tampered with during subsequent authentication procedures. The main functions are as follows:

First, the hash algorithm is applied.

A cryptographic hash algorithm, such as SHA256, is applied to the collected log data to generate a unique hash value. This verifies that the log data has not been tampered with.

Second, the log integrity is guaranteed.

The generated hash value ensures the integrity of the compliance log and provides reliability when the authentication authority subsequently reviews the log. This hash value is provided to external authentication authorities to help verify the legitimacy of the log.

Third, the hash value is stored.

The generated hash value is stored in a secure database and may be referenced during subsequent authentication procedures. The stored hash value serves as a critical element in verifying that the log data has not been tampered with.

The third step is the authentication application and management stage.

The authentication application and management stage involves applying for and maintaining international and domestic personal information protection-related authentications based on internally generated compliance logs and hash values. Key authentications are managed in accordance with ISO standards and domestic and international regulations, and the procedures for obtaining these authentications are as follows:

First, ISO 27701.

This authentication is for the Personal Information Management System (PIMS). ISO 27701 is an international standard related to personal information protection. The authentication management part reviews compliance with the ISO 27701 authentication criteria, prepares the necessary documents and log data, and then processes the authentication application. ISO 27701 authentication assesses compliance with the standards for personal information protection policies, risk management, and personal information processing activities.

Second, ISO 27001.

This authentication is for the Information Security Management System (ISMS). ISO 27001 is an international standard related to information security. This standard assesses whether the management system necessary to maintain the confidentiality, integrity, and availability of information is in place. The authentication management part manages internal information security policies and procedures in accordance with ISO 27001 standards and generates essential log data to maintain authentication.

Third is ISMS-P.

ISMS-P is a domestic personal information protection and information security management authentication. It assesses compliance with domestic legal requirements. This authentication requires a management system that satisfies both information protection and personal information protection, and the authentication management part collects and manages data to maintain ISMS-P authentication.

Fourth is other authentications.

Other authentications related to personal information protection and information security (e.g., country-specific personal information protection authentication, industry-specific regulatory authentication, etc.) are also managed by the authentication management part. Internal data is managed in accordance with the requirements of each authentication, and the necessary documents and materials are prepared and submitted for authentication.

At this stage, the authentication management part 600 manages all matters necessary for maintaining authentication, from the application process onward, and continuously performs authentication maintenance and renewal procedures in cooperation with the authentication authority.

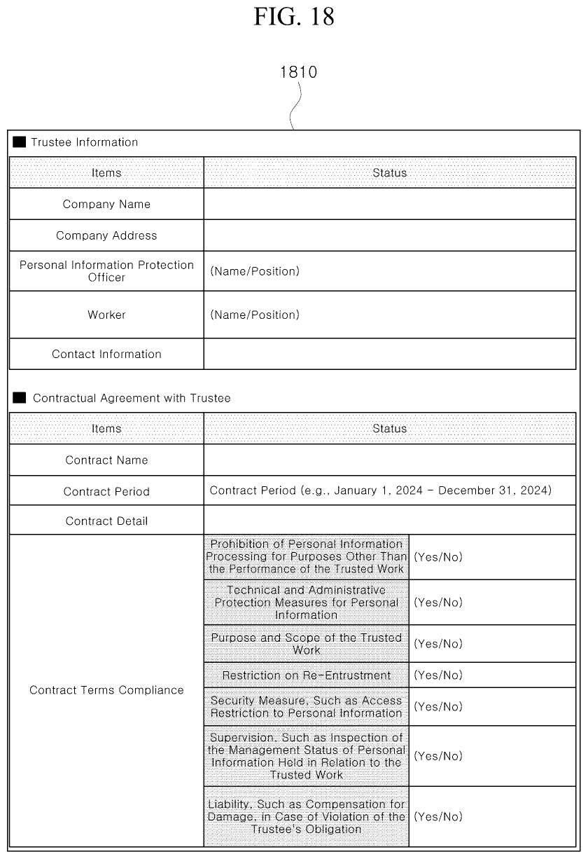

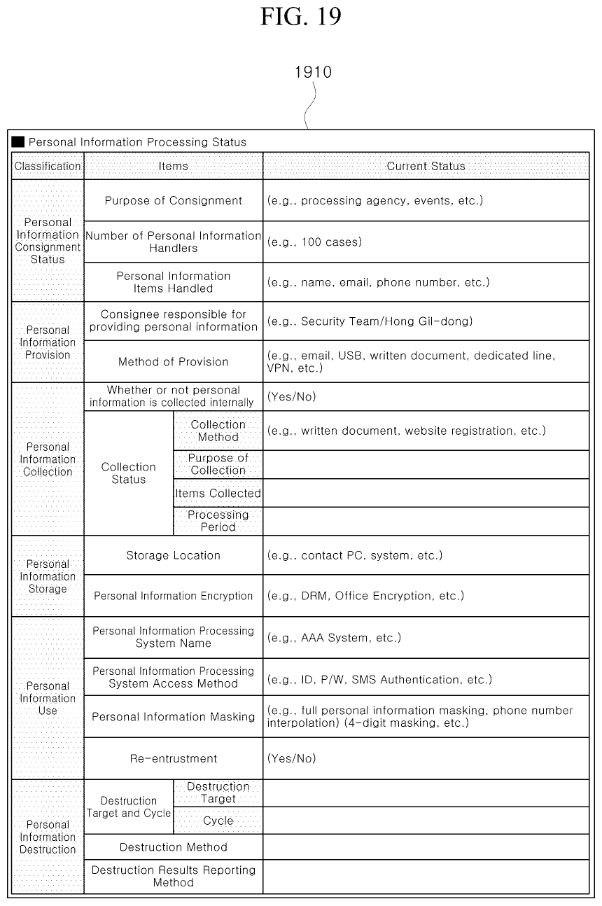

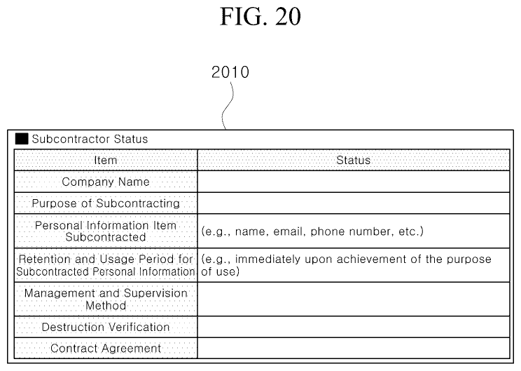

For example, FIG. 18 illustrates a status of trustees 1810 according to the present disclosure, FIG. 19 illustrates a status of personal information processing 1910, and FIG. 20 illustrates a status of sub-trustees 2010.

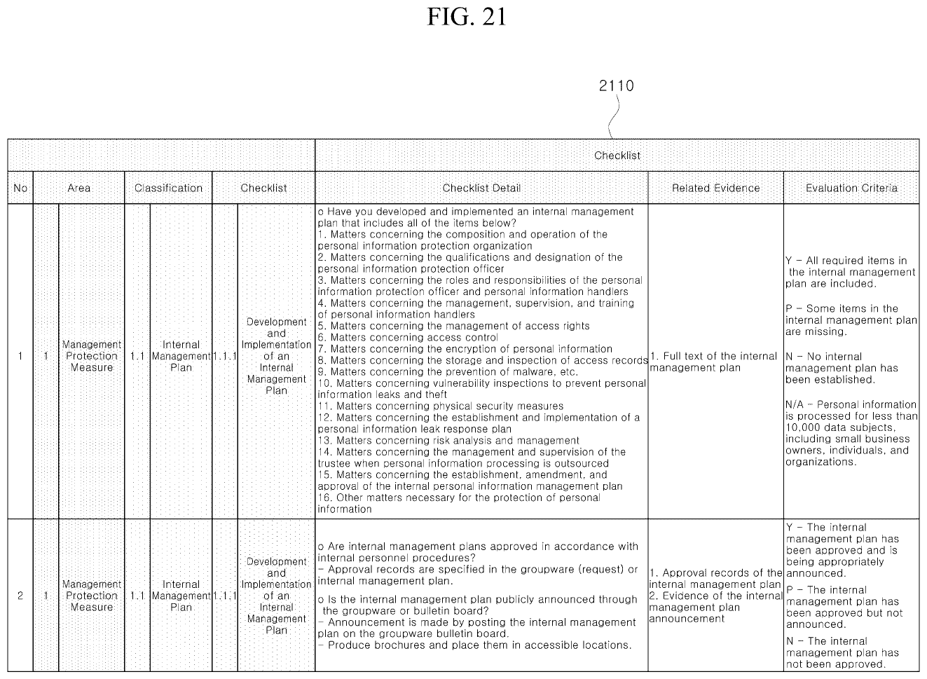

FIG. 21 is a diagram illustrating inspection items of the inspection checklist according to this disclosure.

Referring to FIG. 21 (2110), the inspection items of the inspection checklist will be described.

The inspection items are categorized by order, area, category, inspection item, inspection item details, related evidence, and evaluation criteria.

The area includes administrative protection measures.

The classification includes the internal management plan.

The inspection items include the establishment and implementation of the internal management plan.

The related evidence includes the full text of the internal management plan.

The evaluation criteria are as follows:

Y—All required items in the internal management plan are included.

P—Some items in the internal management plan are missing.

N—The internal management plan was not collected.

N/A—Personal information is processed for less than 10,000 data subjects, including small business owners and individual organizations.

The inspection items, related evidence, and evaluation criteria are as follows.

The First, the first inspection item details, related evidence, and evaluation criteria are as follows.

Question) Are you including all of the following in your personal information protection documents (internal management plan and related regulations)?

1. Matters concerning the composition and operation of the personal information protection organization

2. Matters concerning the qualifications and designation of the personal information protection officer

3. Matters concerning the roles and responsibilities of the personal information protection officer and personal information handlers

4. Matters concerning the management, supervision, and training of personal information handlers

5. Matters concerning the management of access rights

6. Matters concerning access control

7. Matters concerning the encryption of personal information

8. Matters concerning the storage and inspection of access records

9. Matters concerning the prevention of malware, and the like

10. Matters concerning vulnerability inspections to prevent personal information leaks and theft

11. Matters concerning physical security measures

12. Matters concerning the establishment and implementation of a personal information leak response plan

13. Matters concerning risk analysis and management

14. Matters concerning the management and supervision of the trustee when entrusting personal information processing tasks

15. Matters concerning the establishment, amendment, and approval of the internal personal information management plan

16. Other matters necessary for the protection of personal information

The relevant evidence is as follows:

1. Full text of the personal information protection policy document internal management plan and personal information protection-related regulations

The evaluation criteria are as follows:

Y—All required items in the policy document are included.

P—Some items in the policy document are missing.

N—No policy document has been established.

N/A—Processing personal information of less than 10,000 data subjects, including small business owners, individuals, and organizations.

The second, the details of the second inspection item, related evidence, and evaluation criteria are as follows.

Question) Is the personal information protection policy document (internal management plan and personal information protection-related regulations) approved by the CEO (or Chief Personal Information Officer) according to internal personnel procedures?
Specify the approval record in the groupware (deliberation) or internal management plan.

Question) Is the personal information protection policy document internal management plan and personal information protection regulations publicly disclosed within the company?
Public disclosure through posting the internal management plan on the groupware bulletin board.
Public disclosure through publication of brochures and other materials in accessible locations.

The relevant evidence is as follows:
1. Approval records
2. Publication evidence

The evaluation criteria are as follows:
Y—Approval obtained and appropriately disclosed.
P—Approval obtained but not disclosed.
N—Approval not obtained.

The third, the details of the third inspection item are as follows:

Question) Is the personal information protection policy document (internal management plan and personal information protection-related regulations) reviewed regularly at least once a year?
Annual review history of the personal information protection policy document (internal management plan and personal information protection-related regulations)
Approval and announcement history of revisions

The relevant evidence is as follows:
1. Personal information protection policy document (internal management plan and personal information protection-related regulations) revision history

The evaluation criteria are as follows:
Y—Personal information protection policy document revision history is recorded.
N—Personal information protection policy document revision history is not recorded.

The fourth, the details of the fourth inspection item are as follows:

Question) Are you inspecting and managing the implementation of your personal information protection policy document (internal management plan and personal information protection-related regulations) at least once a year and implementing corrective measures for any deficiencies?
The personal information protection officer conducts an inspection of the implementation of the personal information protection policy document at least once a year.
The personal information protection officer reviews and approves the inspection results.
Required inspection items during the implementation inspection.
1. Access authority management.
2. Access log storage and inspection.
3. Encryption measures.

The relevant evidence is as follows.
1. Personal information protection policy implementation inspection plan.
2. Personal information protection policy implementation inspection report.

The evaluation criteria are as follows.
Y—We inspect the implementation of our personal information protection policy at least once a year.
P—We inspect the implementation of our personal information protection policy, but some required inspection items are missing.
N—We do not inspect the implementation of our personal information protection policy.

The fifth, the details of the fifth inspection item are as follows:

Question) Is a Personal Information Protection Officer officially designated as someone with appropriate qualifications?
Specify the personal information protection officer in the personal information protection policy, organizational chart, and personal information processing policy
1. Business owner or representative
2. Executive (if there is no executive, the head of the department responsible for personal information processing)

※ For small businesses, the business owner or representative is deemed to be designated as the Personal Information Protection Officer without a separate designation.

Relevant evidence is as follows:

Official documents confirming the designation of the personal information protection officer, such as the personal information protection policy, organizational chart, personal information processing policy, and personnel appointments.

The evaluation criteria are as follows:

Y—A personal information protection officer has been designated and the requirements for designation have been met.

P—A personal information protection officer has been designated, but the requirements for designation are not met or the designation is not formally documented.

N—No personal information protection officer has been designated.

The sixth, the details of the sixth inspection item are as follows:

Question) Are personal information handlers required to sign a security pledge to protect personal information?

\textcircled{1} Confirm whether a security pledge is required upon hiring or leaving the company.

\textcircled{2} Confirm whether a security pledge is required for all personal information handlers on a regular basis (once a year).

### Security Pledge Structure

Contains content that highlights the following responsibilities to prevent personal information leakage.
1. Personal information handler obligations for personal information protection
2. Disciplinary actions for violations
3. Pledge Examples: Personal information security pledge, confidentiality pledge, and the like, related evidence is as follows.
1. Security pledge for new employees
2. Security pledge for retired employees

The evaluation criteria are as follows.
Y—Security pledges are being collected regularly and without omission at least once a year.
P—Security pledges are being collected, but some individuals are missing them.
N—Security pledges are not being collected.

The seventh, the details of the seventh inspection item are as follows:

Question) Are personal information protection training provided to the Personal Information Protection Manager and personal information handlers at least once a year?

### Prepare a Personal Information Protection Training Plan

\textcircled{1} Prepare an annual personal information protection training plan including the following:
1. Training purpose and target
2. Training content
3. Training schedule and method

### Evidence of Personal Information Protection Training for Each Job

\textcircled{1} Confirmation of personal information protection training for personal information handlers
\textcircled{2} Confirmation of training conducted at least once a year
\textcircled{3} Confirmation of management and supervision of those who have not completed training

※ Personal information handler: A person who processes personal information under the direction and supervision of a personal information processor, such as an employee, dispatched worker, or part-time worker.

Relevant evidence is as follows:
1. Personal information protection training plan
2. Personal information protection training results
3. Personal information protection training materials
4. Personal information protection training completion certificate
5. Personal information protection training attendee list
6. Other evidence of personal information protection training

The evaluation criteria are as follows:
Y—A personal information protection training plan has been established, regular training is conducted at least once a year, and supervision is provided for those who have not completed the training.
P—Personal information protection training is conducted at least once a year, but supervision is not provided for those who have not completed the training.
N—Personal information protection training is not conducted at least once a year.

The eighth, the details of the eighth inspection item are as follows:

Question) Have you established response procedures and methods in case of loss, theft, or leakage of personal information?
A personal information leak response plan must be established and implemented, including matters such as reporting and notifying of leaks, receiving damage reports, and providing relief for damages.
The occurrence of an incident must be reported immediately to the consignor.

The relevant evidence is as follows:
1. Personal information leak response plan

The evaluation criteria are as follows:
Y—A personal information leak response plan is established and implemented.
N—A personal information leak response plan is not established.

The ninth, the details of the ninth inspection item are as follows:

Question) While subcontracting without prior consultation is prohibited in principle, if subcontracting is unavoidable, is it being done in accordance with the standards?
Subcontracting must be done with the consent of the consignor.
A subcontracting agreement must be prepared based on the consignor's consignment agreement.
Personal information may not be used or provided beyond the scope of the work entrusted by the consignor.

The relevant evidence is as follows:
1. Evidence of prior approval.
2. Subcontracting agreement.

The evaluation criteria are as follows:
Y—Subcontracting personal information is being done in accordance with the relevant standards.
N—Subcontracting personal information without the consignor's approval.

The tenth, the details of the tenth inspection are as follows:

Question) When re-entrusting personal information, are you conducting periodic inspections and training?

The relevant evidence is as follows:
1. Regular inspection and training plan for re-entrustees
2. Results of regular inspection and training for re-entrustees

The evaluation criteria are as follows:
Y—Re-entrustees are managed and supervised through education and inspections.
N—Re-entrustees are not managed and supervised through education and inspections.
N/A—Personal information is not re-entrusted.

The eleventh, the details of the eleventh inspection item are as follows:

Question) Have you established a personal information processing policy that includes all of the required items below and has it been made publicly available in a manner easily understandable to the data subject?
Personal information processing policy information (Personal information processing policy preparation guidelines, Personal Information Protection Commission, April 2024)
1. Title (required)
2. Purpose of personal information processing (required)
3. Items of personal information processing (required)
4. Matters regarding the processing of personal information of children under 14 years of age (recommended, if applicable)
5. Personal information processing and retention period (required)
6. Matters Regarding the Procedures and Methods for Deleting Personal Information (required)
7. Matters regarding the provision of personal information to third parties (required, if applicable)
8. Criteria for determining continued additional use and provision (required, if applicable)
9. Personal information processing matters concerning consignment (required, if applicable)
10. Matters concerning overseas collection and transfer of personal information (required, if applicable)
11. Matters concerning measures to ensure the security of personal information (required)
12. Possibility of disclosure of sensitive information and method of selecting nondisclosure (required, if applicable)
13. Matters regarding the processing of pseudonymized information (required, if applicable)
14. Matters regarding the installation and operation of automatic personal information collection devices and refusal thereof (required, if applicable)
15. Matters regarding the collection, use, and refusal of behavioral information collected by third parties through automatic personal information collection devices (recommended, if applicable)
16. Matters regarding the rights, obligations, and methods of exercising such rights of the data subject and legal representative (required)
17. Matters regarding the name of the personal information protection officer, the department in charge of personal information affairs, and the department handling complaints (required)
18. Matters regarding the designation of a domestic representative (required, if applicable)
19. Remedies for Infringement of the rights of data subjects (recommended)
20. Matters concerning the operation and management of fixed image processing devices (required, if applicable)
21. Matters concerning the operation and management of mobile image processing devices (required, if applicable)
22. Matters voluntarily established by the personal information processor in its personal information processing policy, including personal information processing standards and protective measures (recommended)
23. Matters concerning changes to the personal information processing policy (required)

### Disclosure of the Personal Information Processing Policy

\textcircled{1} Established or revised personal information processing policies shall be continuously posted on the current website so that data subjects may easily access them.

\textcircled{2} If posting on the website is not possible, disclosure shall be made through the following methods:
1. Posted in a readily visible location, such as the Personal Information Processor's business premises.
2. Publication in publications, newsletters, promotional materials, or invoices issued at least twice a year.
3. Statement in contracts with data subjects for the provision of goods or services, and the like

The relevant evidence is as follows:
1. Personal information processing policy
2. Evidence of disclosure of personal information processing policy

The evaluation criteria are as follows:
Y—A personal information processing policy has been established and is continuously disclosed, including all required information.
P—Some of the required information in the personal information processing policy is missing or not consistently posted.
N—A personal information processing policy has not been established.
N/A—Personal information is not re-entrusted.

The twelfth, the details of the twelfth inspection item are as follows:

Question) Are access control procedures established and in operation for physical storage locations where personal information is stored, such as computer rooms and archives?
Office access control procedures
Installation of additional control devices, such as fingerprint recognition devices, card keys, and number keys.

The relevant evidence is as follows:
1. Access control procedure documentation
2. Access control application status
3. Access control operation evidence entry log, and the like

The evaluation criteria are as follows:
Y—Access control procedures for physical storage locations are established and in operation.
N—Access control procedures for physical storage locations are not established.

The thirteenth, the details of the thirteenth inspection item are as follows:

Question) Are documents and auxiliary storage media containing personal information stored in a data storage room or a secure location with a locking device?
Documents and auxiliary storage media containing personal information are stored safely.

The relevant evidence is as follows:
1. Evidence that documents or auxiliary storage media containing personal information are stored in a separate, locked location.

The evaluation criteria are as follows:
Y—Documents and auxiliary storage media containing personal information are stored in a secure location.
N—Documents and auxiliary storage media containing personal information are not stored in a secure location.

The fourteenth, the details of the fourteenth inspection item are as follow.

Question) Have you established and implemented a policy to control the entry and exit of auxiliary storage media?
Establish procedures for external import/export of auxiliary storage media within internal regulations.
\textcircled{1} Verify the existence of procedures for external import/export of auxiliary storage media.
\textcircled{2} Verify the existence of permission request and approval procedures for import/export.
\textcircled{3} Verify the auxiliary storage media import/export management ledger for import/export.

The relevant evidence is as follows:
1. Auxiliary storage media import/export control policy.
2. Auxiliary storage media import/export management ledger.

The evaluation criteria are as follows:
Y—Established standards for the export and import of auxiliary storage media and implemented according to control procedures.
P—Insufficient standards for the export and import of auxiliary storage media or no controls in place.
N—No standards for the export and import of auxiliary storage media and no controls in place.

The fifteenth, the details of the fifteenth inspection item are as follows:

Question) Are access rights to the personal information processing system differentially granted to personal information handlers to the minimum extent necessary for performing their duties?
Accounts issued to each personal information handler.
Account sharing prohibited.
If account sharing is unavoidable, measures are required to ensure accountability.
Restrictions on printing and downloading personal information.

The relevant evidence is as follows:
1. List of personal information handlers
2. Status of personal information processing system access rights

The evaluation criteria are as follows:
Y—Personal information handler account permissions are granted to the minimum.
P—Personal information handler account permissions are granted to the minimum, but some individuals have excessive permissions.
N—Personal information handler account permissions are not restricted.

The Sixteenth, the details of the sixteenth inspection item 16 are as follows:

Question) When personnel changes, such as transfers or retirements, occur, are access rights to the personal information processing system promptly changed or deleted?
Changes in personal information processing system permissions due to job changes
Deletion of retiree accounts in the personal information processing system

Related evidence is as follows:
1. Retirement and job change procedures
2. History of account deletion or access permission changes

The evaluation criteria are as follows:
Y—Access permissions are immediately revoked upon retirement or other personnel changes.
N—Access permissions are not immediately revoked upon retirement or other personnel changes.

The seventeenth, the details of the seventeenth inspection item are as follow:

Question) Are you recording the details of granting, changing, and revoking access permissions to the personal information processing system?
Changes in personal information processing system access permissions for at least three years. Storage
Includes the minimum information necessary to ensure accountability, such as account name, name, affiliation, and authority.

Relevant evidence is as follows:
1. Personal information processing system access rights change history
2. Access rights change application form

The evaluation criteria are as follows:
Y—Personal information handler access rights change history is safely stored for at least 3 years.
P—Personal information handler access rights change history is recorded, but the change history may not be clearly confirmed or is not stored for at least 3 years.
N—Personal information handler access rights change history is not recorded.

The eighteenth, the details of the eighteenth inspection item are as follows:

Question) Are measures taken, such as automatically blocking access to the personal information processing system if no work is performed for a certain period of time?
Personal information processing system session timeout, token expiration time settings, and the like

Related evidence is as follows:
1. Evidence of maximum connection time limit settings

The evaluation criteria are as follows:
Y—Personal information processing system timeout function is applied
N—Personal information processing system timeout function is not applied

The nineteenth, the details of the nineteenth inspection item are as follows:

Question) When external access to the personal information processing system is required via an information and communications network, are secure authentication methods being used?
Secure authentication methods: OTP, certificates, security tokens, and the like
Secure connection methods: VPN, dedicated lines, and the like

Related evidence is as follows:
1. Evidence of secure authentication or access methods when accessing the personal information processing system from outside.

The evaluation criteria are as follows:
Y—Remote access to the personal information processing system from outside is restricted.
N—Remote access to the personal information processing system from outside is not restricted.

The twentieth, the details of the twentieth inspection item are as follows:

Question) Is internet access to important terminals processing personal information restricted?
A terminal is considered important if it may perform the following tasks:
1. Personal information may be downloaded or destroyed from the personal information processing system.
2. Access rights to the personal information processing system may be set.

The relevant evidence is as follows:
1. Evidence of internet blocking settings on important terminals.

The evaluation criteria are as follows:
Y—Internet use on critical devices is restricted.
N—Internet use on critical devices is not restricted.
N/A—Not subject to network separation.

The twenty-first, the details of the twenty-first inspection item are as follows:

Question) Personal information processing system are you restricting access to IP addresses, and the like?
Allow access only to specific IPs/MACs through firewalls, and the like
Allow access only to specific IPs/MACs using the router's ACL function
Allow access only to authorized personnel using an access control solution

The relevant evidence is as follows:
1. Evidence of restricted access to personal information processing systems
2. Evidence of security solution operation

The evaluation criteria are as follows:
Y—Access control is set when accessing the personal information processing system.
P—Access control is inadequate when accessing the personal information processing system.
N—Access control is not set when accessing the personal information processing system.

The twenty-second, the details of the twenty-second inspection item are as follows:

Question) Are you safely applying and managing authentication methods for personal information handlers or data subjects in the personal information processing system?
Apply authentication means (passwords, OTPs, etc.) according to the internal management plan or guidelines.
Restrict access to the personal information processing system after a certain number of failed authentication attempts.

The relevant evidence is as follows:
1. Authentication method regulations in the internal management plan.
2. Authentication method threshold settings.

The evaluation criteria are as follows:
Y—Authentication methods are applied and thresholds are set for the personal information processing system.
P—Authentication methods are applied for the personal information processing system, but thresholds have not been set.
N—Authentication methods are not applied for the personal information processing system.

The twenty-third, the details of the twenty-third inspection item are as follows:

Question) When viewing or printing personal information, are you minimizing the number of personal information items printed to only those necessary for business purposes and applying safety measures to safely manage printed and copied materials?
Establish policies/regulations/guidelines for the protection and management of printed and copied materials.
Safety measures such as watermarking, recording print history, and confirming destruction.
When printing personal information (printing, displaying on screen, creating files, etc.), print the minimum amount within the scope of access rights by specifying the purpose.
Establishing a personal information processing system When viewing the full list of personal information, whether or not it is masked.

The relevant evidence is as follows:
1. Evidence of personal information masking

The evaluation criteria are as follows:
Y—Security measures are applied when viewing the full list of personal information.
N—Security measures are not applied when viewing the full list of personal information.

The twenty-fourth, the details of the twenty-fourth inspection item are as follows:

Question) Are access records, including essential items, for the personal information processing system of the personal information handler retained and managed for at least one year?
Essential items: identifier, access date and time, access location information, information on the data subject processed, and tasks performed.
The following cases must be retained and managed for at least two years.
1. In a personal information processing system that processes personal information of more than 50,000 data subjects
2. If the personal information processing system processes unique identification information or sensitive information
3. If the personal information processor is a telecommunications service provider

### ※ Description of Required Access Log Items

Identifier: Account information such as an ID assigned to identify the user connected to the personal information processing system
Access date and time: Time of connection or time of work performed (year-month-day, hour: minute: second)
Access location information: IP address of the computer or server of the user connected to the personal information processing system, and the like
Processed information subject information: Identification information (ID, customer number, student number, employee number, etc.) that allows the personal information handler to determine whose personal information
Tasks performed: Information (collected, created, linked, connected, recorded, stored, retention, processing, editing, searching, printing, correction, recovery, use, provision, disclosure, destruction, etc.) that allows the personal information handler to determine the details of personal information processed using the personal information processing system.

Relevant evidence is as follows:
1. Personal information processing system access logs

The evaluation criteria are as follows:
Y—Personal information processing system access logs, including all required items, are stored and managed for at least one or two years.
P—Personal information processing system access logs are stored, but some information is missing or the retention period is inadequate.
N—Personal information processing system access logs are not stored.

The twenty-fifth, the details of the twenty-fifth inspection item are as follows:

Question) Are personal information processing system access logs checked at least once a month?
Inspection of excessive personal information access, access outside of working hours, reasons for downloading personal information, and the like
“When downloading personal information, the reason for downloading must be confirmed”

Relevant evidence is as follows:
1. Personal information processing system access log inspection plan
2. Personal information processing system access log inspection report

The evaluation criteria are as follows:
Y—Personal information processing system access logs and personal information download reasons are inspected for appropriateness at least once a month
P—Personal information processing system access logs and personal information download reasons are inspected for appropriateness, but inspections are not conducted at least once a month
N—Personal information processing system access logs and personal information download reasons are not inspected for appropriateness

The twenty-sixth, the details of the twenty-sixth inspection item are as follows:

Question) Are you taking the necessary measures on your personal information processing system, personal information handler's computer, and mobile devices to prevent personal information from being disclosed or leaked to unauthorized parties through Internet homepages, P2P, shared settings, and the like?
Blocking access to harmful websites such as P2P
Restricting shared folders
Application of security solutions such as DLP and DRM

The relevant evidence is as follows:
1. Evidence of blocking access to harmful websites on the personal information handler's terminal
2. Evidence of setting shared folder restrictions
3. Evidence of operating security solutions

The evaluation criteria are as follows:
Y—Measures are in place on the personal information handler's terminal to prevent personal information leakage and exposure.
N—Evidence of blocking access to harmful websites on the personal information handler's terminal No measures have been established to prevent personal information leaks and exposure.

The twenty-seventh, the details of the twenty-seventh inspection item are as follows:

Question) Have you established and implemented a password policy for personal information handlers or data subjects accessing the personal information processing system?
The minimum password length is set to 10 characters when combining two or more types of uppercase and lowercase letters, numbers, and special characters, or 8 characters when combining three or more types of characters.
Passwords must be set to expire, changed at least once every six months, and alternate passwords must not be used.
Access restrictions, such as account locks and delay settings, are implemented when incorrect passwords are entered five or more times.
Passwords that are easy to guess, such as consecutive numbers, birthdays, phone numbers, or passwords similar to user IDs, are prohibited.

※ If a password is not used as an authentication method, the following are not applied.

Relevant evidence is as follows:
1. Password policy within the internal management plan
2. Password policy established for the personal information processing system
3. Password change date status

The evaluation criteria are as follows:
Y—Secure passwords that meet the password standards are set and regularly changed.
N—Weak passwords are being used or password policy settings are not being applied.

The twenty-eighth, the details of the twenty-eighth inspection item are as follows:

Question) Are passwords stored using one-way encryption?
Application of a secure one-way encryption algorithm higher than SHA-2
Refer to the latest information, including the KISA Encryption Algorithm and Key Length Guide

※ Not applicable if passwords are not used as an authentication method

Relevant evidence is as follows:
1. Evidence of application of an encryption algorithm to passwords

The evaluation criteria are as follows:
Y—A secure encryption algorithm is applied when storing passwords
N—A secure encryption algorithm is not applied when storing passwords

The twenty-ninth, the details of the twenty-ninth inspection item are as follows:

Question) Are users' resident registration numbers, passport numbers, driver's license numbers, alien registration numbers, credit card numbers, account numbers, and biometric information encrypted and stored using a secure encryption algorithm?
Design of applied symmetric key encryption algorithms (SEED, ARIA-128/192/256, AES-128/192/256, HIGHT, etc.)
Design of applied public key encryption algorithms (RSAES-OAEP, RSAES-PKCS1, etc.) The relevant evidence is as follows:
1. Evidence of personal information encryption application
2. Evidence of encryption algorithm

The evaluation criteria are as follows:
Y—Personal information is encrypted and stored using a secure encryption algorithm.
N—Personal information is stored without encryption using a secure encryption algorithm.

The thirtieth, the details of the thirtieth inspection item are as follows:

Question) When sending and receiving passwords, personal information, and authentication information through information and communications networks, are these transmitted and received encrypted?
Apply SSL (https) or install encryption program

Related evidence is as follows:
1. SSL certificate information
2. Evidence of personal information encryption using encryption solutions, and the like

The evaluation criteria are as follows:
Y—Personal information and authentication information transmitted and received via information and communications networks are encrypted.
N—Personal information and authentication information transmitted and received via information and communications networks are not encrypted.

The thirtieth-first, the details of the thirtieth-first inspection item are as follows:

Question) When storing personal information on PCs, mobile devices, and auxiliary storage media, is it encrypted?
When downloading files from the personal information processing system, the files are downloaded with password settings applied.
Manually setting a password for personal information files in Office programs Provided password settings, and the like
Use of secure USB drives, and the like when using auxiliary storage media
Application of DRM

The relevant evidence is as follows:
1. Evidence confirming the application of encryption when storing personal information files on PCs, auxiliary storage media, and the like

The evaluation criteria are as follows:
Y—Personal information is encrypted when stored.
N—Personal information is not encrypted when stored.

The thirtieth-second, the details of the thirtieth-second inspection item are as follows:

The relevant evidence is as follows:
1. Encryption key management procedures

The evaluation criteria are as follows:
Y—Secure encryption key management procedures are established and implemented.
N—Secure encryption Failure to establish and implement key management procedures

The thirtieth-third, the details of the thirtieth-third inspection item are as follows:

Question) Are you installing and operating a security program to check for and treat malware on the personal information handler's PC?
Automatic updates or updates at least once a day
Real-time monitoring and daily scheduled scans are performed

The relevant evidence is as follows:
1. Security program installation history
2. Security program inspection history
3. Security program update history

The evaluation criteria are as follows:
Y—Security program is installed, real-time monitoring is running, and daily updates are performed
P—Security program is installed, but daily updates are not performed or real-time monitoring is not configured
N—Security programs are not installed or operated.

The thirtieth-fourth, the details of the thirtieth-fourth inspection item are as follows:

Question) If a security update notice is issued for an application or operating system software used on the personal information handler's PC, are you immediately applying the update?

Relevant evidence is as follows:
1. A screen that allows you to check for security updates on the personal information handler's PC.
2. Evidence that verifies whether security updates are being applied to applications installed on the PC.
3. Update-related notices.

The evaluation criteria are as follows:
Y—Security updates are immediately applied when announced.
N—Security updates are not immediately applied.

The thirtieth-fifth, the details of the thirtieth-fifth inspection item are as follows:

Question) Do you have a crisis response manual and backup and recovery plan in place to prepare for disasters such as fire, flood, and power outages, and do you regularly review them?

※ Unless you fall under the following categories, you may be excluded from the inspection items.
Large corporations, medium-sized enterprises, and public institutions that process personal information for more than 100,000 data subjects.
Personal information processors that are small and medium-sized enterprises or organizations that process personal information for more than 1 million data subjects.

The relevant evidence is as follows:
1. Crisis response manual (document)
2. Backup and recovery policies and procedures (document)

The evaluation criteria are as follows:
Y—Crisis response procedures, including backup and recovery plans, are established.
P—Crisis response procedures are established. However, backup and recovery plans are missing, or backup and recovery plans exist, but crisis response procedures are inadequate.
N—Crisis response procedures not established

The thirtieth-sixth, the details of the thirtieth-sixth inspection item are as follows:

Question) In addition to the personal information provided by the consignor, if additional personal information is collected for the consignor's business processing, are consent obtained through appropriate means, such as by notifying all necessary consent requirements and highlighting important information?
Information required for notification in the consent form
1. Purpose of collection and use of personal information
2. Items of personal information to be collected
3. Period of retention and use of personal information
4. The right to refuse consent and, if there are any disadvantages resulting from refusal of consent, the details of such disadvantages
5. In case of provision to a third party Recipient, purpose of use by the recipient, period of use, items provided, right to refuse consent, and disadvantages of consent
Method of displaying important information in the consent form
1. The font size should be at least 9 points and at least 20% larger than other content to ensure legibility.
2. The content should be clearly indicated through font color, boldness, or underlining.
3. If there are many important items to consent to, If the content is difficult to clearly distinguish, display it separately from other content so that important information may be easily identified.

The relevant evidence is as follows:
1. Personal information collection and use consent screen

The evaluation criteria are as follows:
Y—Personal information is being collected internally after providing all required notices and obtaining consent.
N—Personal information is being collected internally without providing required notices or providing information.

The thirtieth-seventh, the details of the thirtieth-seventh inspection item are as follows:

Question) Are you promptly destroying personal information after confirming that the retention period has expired or the business purpose has been achieved?
Create personal information destruction conditions and cycle
Create personal information destruction history
Request for generation of evidence of personal information destruction, such as a

“Personal Information Destruction Confirmation Form”

The relevant evidence is as follows:
1. Personal information destruction procedure
2. Personal information destruction batch settings
3. Personal information destruction confirmation form
4. Personal information destruction history

The evaluation criteria are as follows:
Y—Destruction criteria and procedures are established and post-destruction history is managed.
P—Destruction criteria or procedures are established, but destruction history is not managed.
N—Destruction criteria and procedures are not established. No

The thirtieth-eighth, the details of the thirtieth-eighth inspection item are as follows:

Question) If personal information must be retained even after the purpose of use has been achieved, is it stored and managed separately from other personal information in operation?
Write the conditions and cycle for separate storage of personal information.

The relevant evidence is as follows.
1. Evidence of separate storage of personal information.

The evaluation criteria are as follows.
Y—Personal information that requires storage even after the purpose has been achieved is safely stored separately from the personal information in operation.
N—Personal information that requires storage even after the purpose has been achieved is stored without being separated from the personal information in operation.

The thirtieth-ninth, the details of the thirtieth-ninth inspection item are as follows:

Question) Is personal information being destroyed in the following secure manner?
PC, Personal information stored in electronic file formats, such as auxiliary storage media and mailboxes, is deleted in a manner that renders the records unrecoverable using technical methods that render the records unrecoverable.
Personal information printed on paper documents is destroyed using non-recoverable methods, such as shredding or incineration.

The relevant evidence is as follows:
1. Evidence of destruction of personal information stored in electronic file format.
2. Evidence of document shredders and document shredding bins.

The evaluation criteria are as follows:
Y—Personal information is being destroyed in a secure manner.
N—Personal information is not being destroyed.

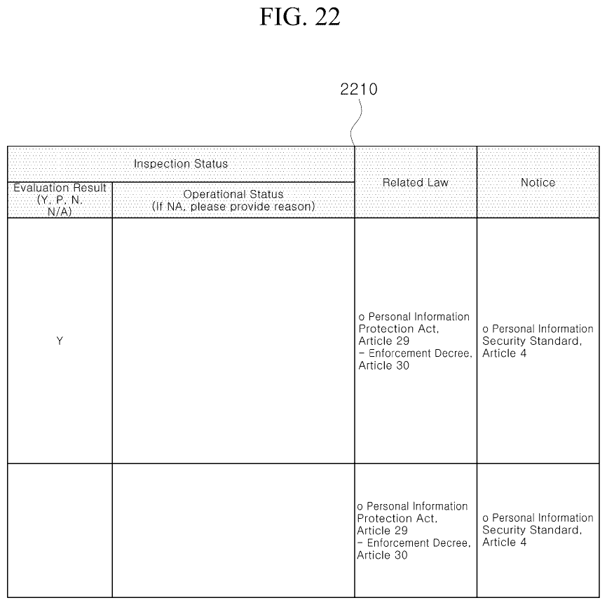

FIG. 22 is a diagram illustrating an inspection status of an inspection checklist according to the present disclosure.

The inspection status of the inspection checklist is described with reference to FIG. 22 (2210).

The inspection status is divided into inspection status, related laws, and related notices.

The related laws are Article 29 of the Personal Information Protection Act and Article 30 of the Enforcement Decree.

The related notice is Article 4 of the Personal Information Security Measures Standards.

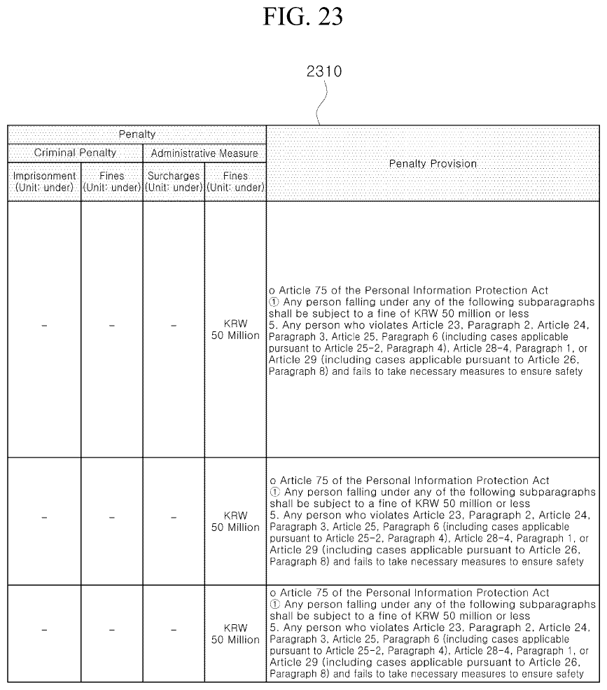

FIG. 23 is a diagram illustrating penalty provisions of the inspection checklist according to the present disclosure.

The penalty provisions of the inspection checklist are explained with reference to FIG. 23 (2310).

The penalty provisions are divided into penalties and penalty provisions.

Penalties are divided into criminal penalties and administrative dispositions.

Penalties are divided into imprisonment and fines.

Administrative dispositions are divided into fines and surcharges. Surcharges are The fine may be up to 50 million won.

The penalty provision is Article 75 of the Personal Information Protection Act.

According to Article 75 of the Personal Information Protection Act, \textcircled{1} A person who falls under any of the following subparagraphs shall be subject to a fine of not more than 50 million won.

No. 5) A person who violates Article 23 Paragraph 2, Article 24 Paragraph 3, Article 25 Paragraph 6 (including cases where Article 25-2 Paragraph 4 applies), Article 28-4 Paragraph 1, or Article 29 (including cases where Article 26 Paragraph 8 applies) and fails to take necessary measures to ensure safety.

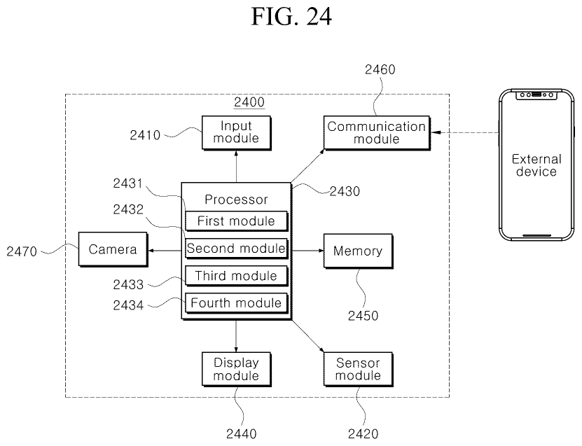

The entire system of the present disclosure has been described above with reference to FIGS. 1 to 23. Hereinafter, the compliance requirement analysis and inspection automation process according to the present disclosure will be described in detail with reference to FIGS. 24 to 32.

FIG. 24 is a diagram illustrating a configuration of a compliance requirement analysis and inspection automation device according to the present disclosure.

Referring to FIG. 24, a compliance requirement analysis and inspection automation device 2400 includes an input module 2410, a sensor module 2420, a processor 2430, a display module 2440, a memory 2450, a communication module 2460, and a camera module 2470.

The input module 2410 collects regulatory data on personal information by country.

The sensor module 2420 senses data.

The processor 2430 performs a control method according to the process.

That is, the processor 2430 may be configured to collect regulatory data on personal information by country through the input module 2410, classify and relearn a policy tag based on the regulatory data collected through the input module, analyze at least one of a company's contract, a term and condition, a policy, a guideline, or a personal information processing policy included in the regulatory data to classify the company's security requirement into a personal information lifecycle and a security control item, control the display 2440 to display the personal information lifecycle and security control items, verify compliance with the security requirement; and manage risk assessment and risk management based on the verified result.

Here, the personal information lifecycle refers to the collection, use, provision, and destruction of the personal information.

Here, the security control item refers to matters other than the collection, use, provision, and destruction of personal information, such as policy establishment, organizational operation (personal information education, access authority management, access control, etc.), technical protection measures (authentication method management, personal information encryption, etc.), and protection of data subject rights.

The processor 2430 may investigate a personal information protection regulation by country, and classify the investigated personal information protection regulation into a micro-regulation or common regulation.

Furthermore, the processor 2430 performs at least one of crawling, upload, link registration, and input of the regulatory data, derives a key keyword for each provision of the regulatory data, and assigns a tag for personal information regulation, and calculates a similarity of the tag content.

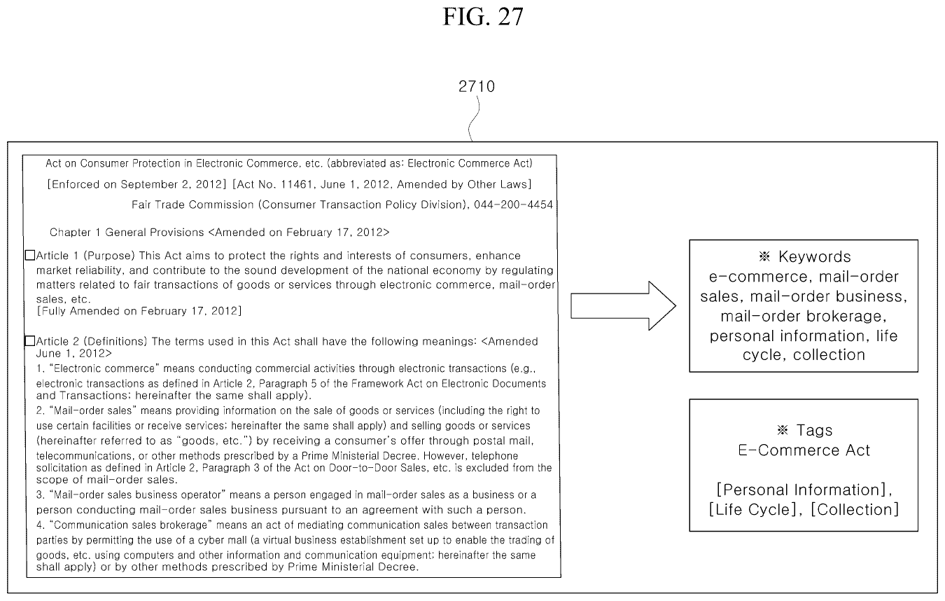

Based on an update occurring to the regulatory data, the processor 2430 assigns a tag to the updated regulatory data, and calculates a similarity between the updated provision in the updated regulatory data and an existing provision. A detailed description for this is provided in FIG. 27.

The processor 2430 maps the security requirement described below with a result value of the risk analyzed from the compliance and security risk analysis part 300, calculates whether the result value reaches the security requirement's reference value, based on the result value being greater than or equal to the reference value, classify the compliance as being met or requiring verification, and based on the result value being less than the reference value, classify the compliance as not being met or requiring verification.

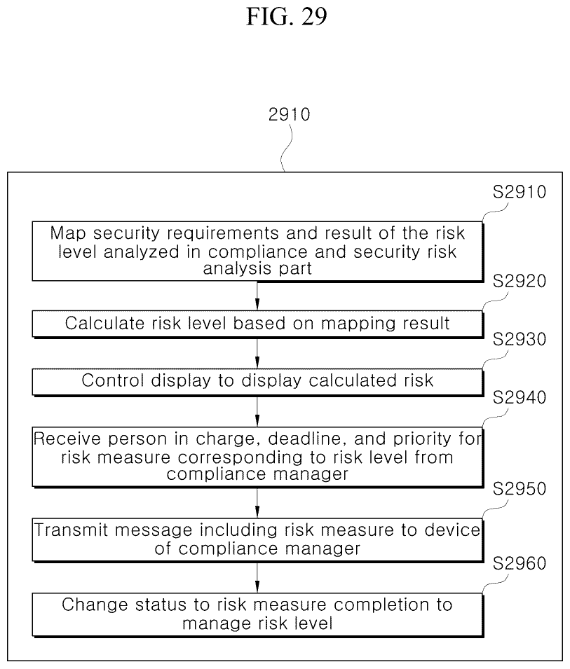

Based on the result value being requiring verification, the processor 2430 calculate the result value by mapping the result value of another module or receive an input value from the compliance manager. A detailed description of this is provided in FIG. 29.

The processor 2430 maps the security requirement with a result value of the risk level analyzed in the compliance and security risk analysis part 300, calculates a risk level based on the mapped result, and controls the display 2440 to display the calculated risk level, and the risk level includes at least one of a possibility of fine, a risk of regulatory violation, or a risk of personal information leakage.

The processor 2430 receives a person responsible for performing a risk action corresponding to the risk level, a deadline, and a priority from the compliance manager, and transmits a message containing a risk action detail to the compliance manager's or the person in charge's device.

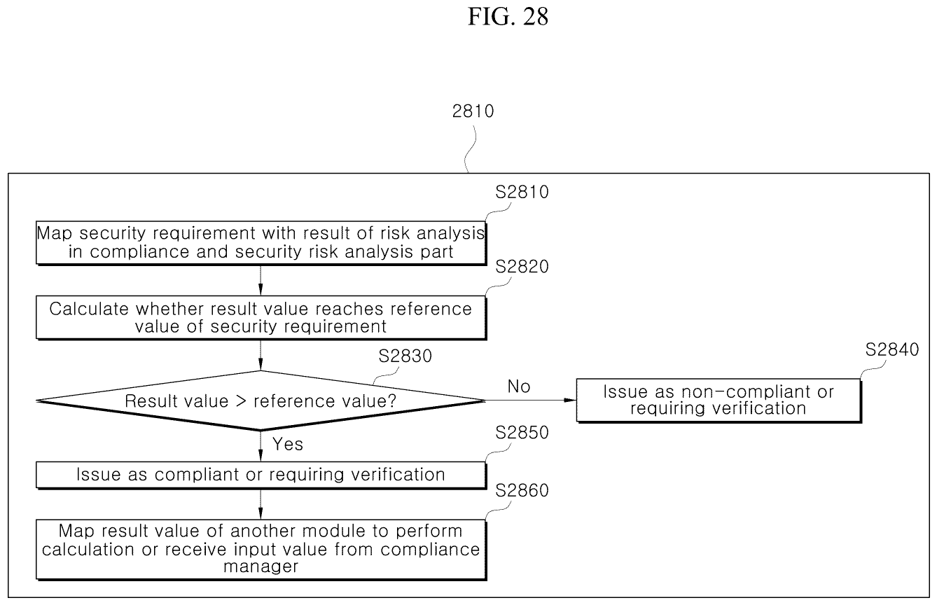

When a risk action trigger occurs, the processor 2430 manages the risk level by changing a status to risk action completed. A detailed description of this is provided in FIG. 28.

However, the components illustrated in FIG. 24 are not essential for implementing the present disclosure according to the present disclosure, and thus, the present disclosure described in this specification may include more or fewer components than the components listed above.

Meanwhile, the processor 2430 of FIG. 24 may be identical to the processor 50 of FIG. 1 described above, in which case all operations and controls described above in FIGS. 1 to 23 may be performed identically by the processor 2440 of FIG. 24.

The display 2440 displays a graphic image according to a control command from the processor 2430.

The memory 2450 stores at least one process for performing operations and stores user input and data.

The communication module 2460 transmits and receives data with an external device.

Here, the external device includes an external device such as a smartphone, a PC, a laptop, a tablet PC, and the like.

The camera module 2470 captures an image of the front.

The camera module 2470 photographs a subject in front according to the control command from the processor 2430.

The communication module 2460 may include one or more components that enable communication with an external device, and may include, for example, at least one of a broadcast reception module, a wired communication module, a wireless communication module, a short-range communication module, or a location information module.

The input module 2410 is for inputting image information (or signals), audio information (or signals), data, or information input from a user, and may include at least one camera, at least one microphone, and at least one user input module. Voice data or image data collected by the input module 2410 may be analyzed and processed as user control commands.

The display module 2440 displays (outputs) information processed in the present disclosure. For example, the present disclosure may display execution screen information of a running application program (e.g., an application), or UI (User Interface) or GUI (Graphical User Interface) information based on such execution screen information.

The memory 2450 may store data supporting various functions of the present disclosure and programs for the operation of the control unit. It may store input/output data (e.g., music files, still images, videos, etc.), multiple application programs (or applications), data for the operation of the device, and commands. At least some of these application programs may be downloaded from an external server via wireless communication.

The memory 2450 may include at least one type of storage medium among a flash memory type, a hard disk type, an SSD (Solid State Disk) type, an SDD (Silicon Disk Drive) type, a multimedia card micro type, a card type memory (e.g., SD or XD memory, etc.), random access memory (RAM), static random access memory (SRAM), read-only memory (ROM), electrically erasable programmable read-only memory (EEPROM), programmable read-only memory (PROM), magnetic memory, a magnetic disk, and an optical disk. In addition, the memory 2450 is separate from the present disclosure, but may be a database connected with wire or wirelessly, and may be implemented as a database system.

The processor 2430 may include at least one core, a memory that stores data regarding an algorithm for controlling the operation of components within the present disclosure or a program that reproduces the algorithm, and at least one processor (not shown) that performs the aforementioned operations using the data stored in the memory. In this case, the memory and the processor may be implemented as separate chips. Alternatively, the memory and the processor may be implemented as a single chip.

Furthermore, the processor 2430 may control any one or a combination of the components described above to implement various embodiments of the present disclosure described in FIGS. 24 to 32 below.

Depending on the performance of the components illustrated in FIG. 24, at least one component may be added or deleted. Furthermore, those skilled in the art will readily understand that the mutual positions of the components may vary depending on the performance or structure of the system.

Meanwhile, each component illustrated in FIG. 24 represents software and/or hardware components such as Field Programmable Gate Array (FPGA) and Application Specific Integrated Circuit (ASIC).

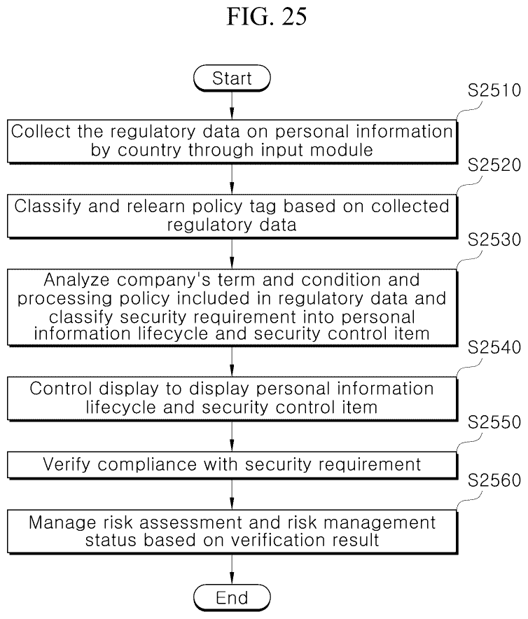

FIG. 25 is a diagram illustrating a flowchart of a method for compliance requirement analysis and inspection automation. The present disclosure is implemented by the processor 2430 of the compliance requirement analysis and inspection automation device 100 or the compliance requirement analysis and inspection automation device 2400.

The processor 2430 collects the regulatory data on the personal information by country through the input module 2410 (step S2510).

The processor 2430 classifies and relearns a policy tag based on the collected regulatory data (step S2520).

The processor 2430 analyzes the company's term and condition and processing policy included in the regulatory data and classifies a security requirement into a personal information lifecycle and a security control item (step S2530).

The processor 2430 controls the display 2440 to display the personal information lifecycle and the security control item (step S2540).

The processor 2430 verifies compliance with the security requirement (step S2550).

The processor 2430 manages risk assessment and risk management status based on the verification result (step S2560).

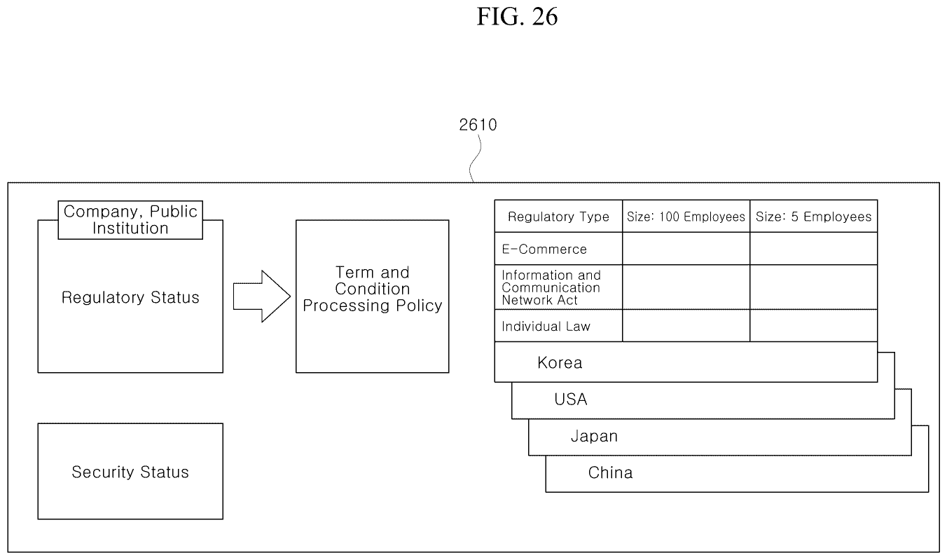

FIG. 26 is a diagram illustrating a core concept of the present disclosure according to the present disclosure.

The core concept of the present disclosure will be described with reference to FIG. 26 (2610).

The processor 2430 identifies the regulatory status of companies and public institutions, extracts personal information status from terms and conditions and processing policies, and classifies and stores the information according to the personal information lifecycle.

The regulations include e-commerce, the Information and Communications Network Act, and individual laws, and are determined differently for businesses with 100 employees and businesses with 5 employees.

Furthermore, the regulations may vary by country, such as Korea, the United States, Japan, and China.

The processor 2430 may also assess and process the security status of companies and public institutions, as described above.

The processor 2430 of the present disclosure may include four modules 2431, 2432, 2433, and 2434.

That is, the processor 2430 includes a first module 2431 for collecting, analyzing, and refining compliance data, a second module 2432 for automating the analysis of corporate information processing status and security requirements, a third module 2433 for compliance inspection, and a fourth module 2334 for compliance risk assessment and management.

The functions of each module are described below.

First, the first module 2431 collects country-specific personal information regulations and automatically classifies and relearns policy tags. Its detailed operations are as follows:

1. Perform at least one of crawling, uploading, link registration, and inputting country-specific personal information-related regulatory data.

2. Derive key keywords for each provision of the regulatory data, assign tags to each personal information regulation, and calculate the similarity between the tag contents.

3. When the above regulatory data is updated, tags are assigned to the updated regulatory data, and the similarity between the updated provisions and existing provisions in the updated regulatory data is calculated.

4. Personal information protection regulations are investigated by country.

5. Tags are assigned to each investigated personal information protection regulation.

6. Each assigned tag is verified and the investigated personal information protection regulations are classified into micro-regulations or common regulations.

Second, the second module 2432 analyzes the company's terms and conditions and processing policies, categorizes security requirements into personal information lifecycle and security control items, and displays them on the screen. The detailed operation is as follows.

1. Input the company's general status and personal information processing status.

Register the personal information processing policy and terms of use for the subject of the inspection. Specifically, personal information status is extracted from the policy and terms and conditions, categorized, and stored according to the lifecycle.

2. Based on the entered information, the compliance collection automation module 110 searches for similar tags.

3. The results are categorized into personal information lifecycle and security control items.

4. Display on the screen for navigation.

Third, the third module 133 automatically checks compliance. The detailed operation is as follows.

1. Retrieve the security requirements derived from the compliance inspection module 120.

2. Retrieve the results from each module of the compliance and security risk analysis part 300.

3. Map the results to the requirements.

4. Calculate whether the result meets the requirements' criteria.

5. If the criteria are not met, the result is classified as non-compliant or requires verification.

6. If the criteria are met, the result is classified as compliant or requires verification.

7. The result of the verification is calculated by mapping the results of other modules or is entered by the user.

8. The inspection results are displayed on the screen.

Fourth, the fourth module 2334 manages the risk assessment and risk management status based on the inspection results. The detailed operations are as follows.

1. Load the security requirements derived from the compliance inspection module 120.

2. Retrieve the results of achieving the criteria for each requirement derived from the company-specific security requirement analysis automation module 130.

3. If the criteria are not met, the requirement is designated as a risk.

4. Calculate the level of the selected risk. For example, factors such as the possibility of fines or the risk of personal information leakage may be considered.

5. Input the person in charge, deadline, priority, etc. for risk measures.

6. Notify the person in charge of the risk measures and repeat the process periodically until the action trigger occurs.

7. If the risk action trigger occurs, the status is changed to Action Completed to manage the risk level.

FIG. 27 is a diagram illustrating an embodiment of deriving key keywords for each clause according to the present disclosure.

Referring to FIG. 27 (2710), an embodiment of deriving key words for each provision is described.

The processor 2430 performs at least one of crawling, uploading, link registration, and inputting the regulatory data, derives key keywords for each provision of the regulatory data and assigns tags for personal information regulations, and calculates the similarity of the tag content. Tag generation is described.

For example, based on the content contained in a provision of the Electronic Commerce Act, if the provision relates to “personal information,” is related to the lifecycle, and relates to “collection,” the processor 2430 generates tags such as [personal information], [lifecycle], and [collection].

For example, if the regulatory data is the Electronic Commerce Act, the processor 2430 derives key keywords for each provision. The key keywords include mail-order sales, mail-order sales business, mail-order sales brokerage, personal information, life cycle, and collection.

When the regulatory data is updated (addition, modification, or deletion of regulations), the processor 2430 tags the updated regulatory data and calculates the similarity between the updated provisions and existing provisions.

FIG. 28 is a diagram illustrating an embodiment of verifying compliance with security requirements according to the present disclosure.

Referring to FIG. 28 (2810), an embodiment of verifying compliance with security requirements will be described.

he processor 2430 maps the security requirements with the results of the risk level analysis in the compliance and security risk analysis part 300 (step S2810).

The processor 2430 calculates whether the result value reaches the reference value of the security requirement (step S2820).

The processor 2430 compares the result value with the reference value (step S2830).

In the case that the result value is below the reference value, the processor 2430 classifies the issue as non-compliant or requiring verification (step S2840).

In the case that the result value is greater than or equal to the reference value, the processor 2430 classifies the issue as compliant or requiring verification (step S2850).

In the case that the issue requires verification, the processor 2430 maps the result value of another module to perform calculations or receives input values from a compliance manager (step S2860).

FIG. 29 is a diagram illustrating an embodiment of calculating risk and executing risk measures according to the present disclosure.

Referring to FIG. 29 (2910), an embodiment of calculating risk and executing risk level measure will be described.

The processor 2430 maps the security requirement and the result of the risk level analyzed in the compliance and security risk analysis part 300 (step S2910).

The processor 2430 calculates the risk level based on the mapping result (step S2920).

The processor 2430 controls the display 2440 to display the calculated risk (step S2930).

Here, the risk level includes at least one of the possibility of fines and the risk of personal information leakage.

The processor 2430 receives the person in charge, deadline, and priority for risk measure corresponding to the risk level from the compliance manager (step S2940).

The processor 2430 transmits a message including the risk measure to the device of the compliance manager (or the person in charge) (step S2950).

When a risk measure trigger occurs, the processor 2430 changes the status to risk measure completion to manage the risk level (step S2960).

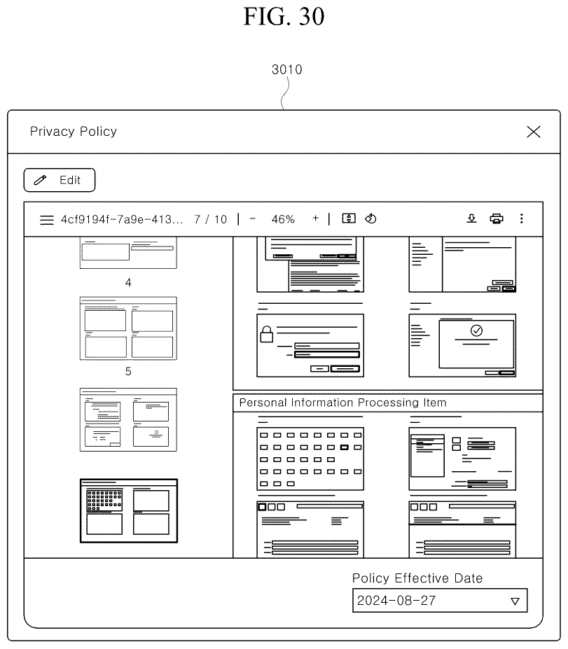

FIG. 30 is a diagram illustrating an embodiment that describes a problem in the prior art according to the present disclosure.

The problem in the prior art will be described with reference to FIG. 30 (3010).

The users entering the system of the present disclosure for the first time may have their own unique processing policy. However, in the prior art, as shown in FIG. 30 (3010), there is no response even in the case that an incorrect processing policy is uploaded, making it difficult for the user to determine whether their processing policy is correct.

The technical feature of the present disclosure compared to the prior art will be described.

In the prior art, only PDF files are uploaded.

The technical feature of the present disclosure will be described.

When a previous processing policy is uploaded, the file containing the processing policy is read to determine whether the file contains text requiring the processing policy, and the user is notified of the appropriate steps.

First, there is the case of a strange file completely unrelated to the processing policy.

The file is asked whether to continue using it, and if the user clicks “No,” the file is deleted.

Second, if the processing policy is incorrect, a survey is conducted.

Third, based on the survey results, the customer's service is identified. The survey informs the customer of any missing information in the processing policy or any information unrelated to the customer's current service that needs to be removed. The survey informs the customer of the required consent form and the data to be entered on the processing policy generation page.

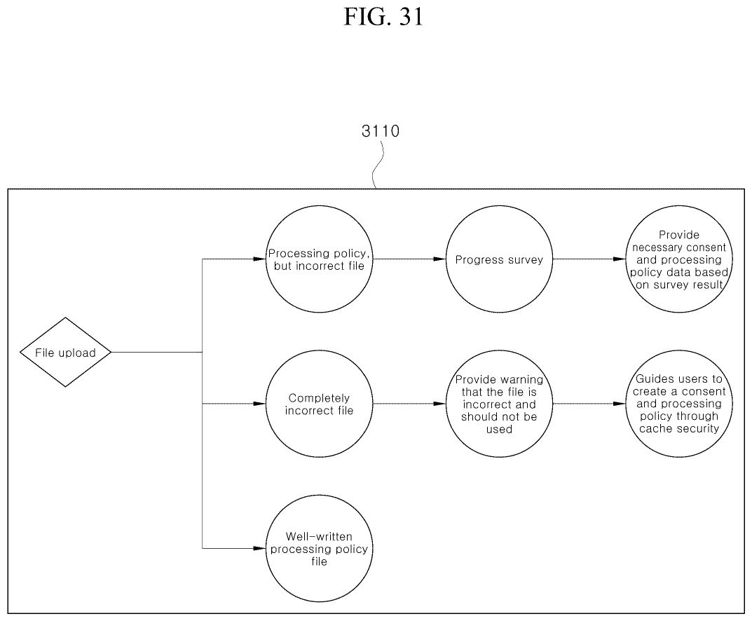

FIG. 31 is a diagram illustrating an embodiment of the processing policy simple review function according to the present disclosure.

The processing policy simple review function is described with reference to FIG. 31 (3110).

Upload a file.

First, in the case that the uploaded file is a processing policy, but is incorrect, the following occurs:

1. Conduct a survey.

2. Based on the survey result, the required consent form and processing policy data are provided.

Second, this is the case where the uploaded file is completely incorrect.

1. A warning message is provided indicating the incorrect file or recommending against its use.

2. The user is prompted to complete a consent form and processing method using the system of the present disclosure.

Third, this is the case where the uploaded file is a well-written processing policy file.

1. The user is encouraged to pay by informing the user of the advantages of using the system of the present disclosure, such as the convenience of continuous history management and editing.

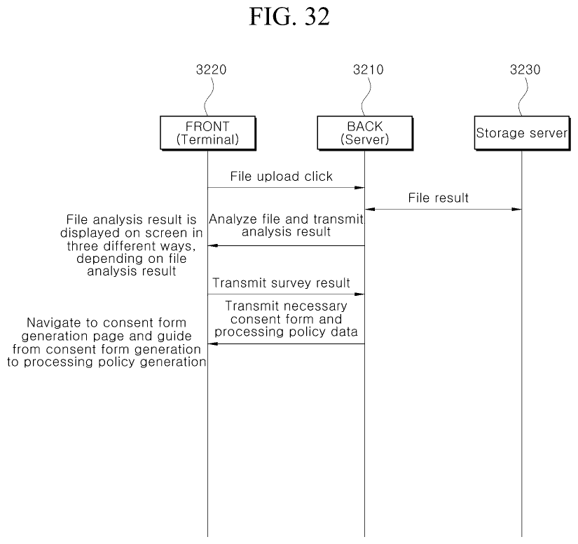

FIG. 32 is a flowchart illustrating a simple processing policy review method according to the present disclosure.

The flowchart of the simple processing policy review method will be described with reference to FIG. 32.

The present disclosure includes a FRONT (terminal) 3220, a BACK (server) 3210, and a storage server 3230.

Upon receiving a file upload click button from a user, the terminal 3220 uploads the file to the server 3210.

The server 3210 transmits the file to the storage server 3230.

The storage server 3230 transmits the file to the server 3210.

The server 3210 analyzes the file and transmits the analysis results to the terminal 3220.

The terminal 3220 displays the file analysis results on the screen. In this case, the file analysis result may be displayed on the screen in three different ways, depending on the file analysis result.

The terminal 3220 transmits the survey result to the server 3210.

The server 3210 transmits the necessary consent form and processing policy data to the terminal 3220.

The terminal 3220 navigates to the consent form generation page and displays a guide on the screen, from consent form generation to processing policy generation.

The various embodiments of the present disclosure do not list all possible combinations but are intended to illustrate representative aspects of the present disclosure. The elements described in the various embodiments may be applied independently or in combination with two or more.

The aforementioned program may include code encoded in a computer language, such as C, C++, JAVA, or machine language, that may be read by the computer's processor (CPU) through the computer's device interface, so that the computer reads the program and executes the methods implemented as the program. This code may include functional code related to functions defining the functions necessary to execute the above methods, and may include control code related to execution procedures necessary for the computer's processor to execute the functions according to a predetermined procedure. Furthermore, this code may further include memory reference-related code regarding the location (address) of the computer's internal or external memory at which additional information or media required for the computer's processor to execute the functions should be referenced. Furthermore, if the computer's processor requires communication with another remote computer or server to execute the functions, the code may further include communication-related code regarding how to communicate with another remote computer or server using the computer's communication module, and what information or media should be sent and received during the communication.

The storage medium refers to a medium that stores data semi-permanently and may be read by a device, rather than a medium that stores data for a short period of time, such as a register, cache, or memory. Specifically, examples of the storage medium include, but are not limited to, ROM, RAM, CD-ROM, magnetic tape, floppy disk, and optical data storage devices. That is, the program may be stored on various recording media on various servers accessible by the computer or on various recording media on the user's computer. In addition, the media may be distributed across network-connected computer systems, so that computer-readable code may be stored in a distributed manner.

The steps of the method or algorithm described in connection with the embodiments of the present disclosure may be implemented directly in hardware, implemented as a software module executed by hardware, or implemented by a combination thereof. The software module may reside in random access memory (RAM), read only memory (ROM), erasable programmable ROM (EPROM), electrically erasable programmable ROM (EEPROM), flash memory, a hard disk, a removable disk, CD-ROM, or any other form of computer-readable recording medium well known in the art to which the present disclosure pertains.

While the embodiments of the present disclosure have been described with reference to the attached drawings, those skilled in the art will appreciate that the present disclosure may be implemented in other specific forms without altering the technical spirit or essential features thereof. Therefore, the embodiments described above should be understood to be illustrative in all respects and not restrictive.

According to the present disclosure, user convenience can be improved by collecting country-specific personal information regulations and automatically classifying and relearning policy tags.

According to the present disclosure, a company's terms and conditions and processing policies can be analyzed to classify security requirements into personal information lifecycle and security control items, and these can be displayed on the screen, thereby improving user convenience.

According to the present disclosure, compliance can be automatically verified and risk assessments and risk management status can be managed based on the check results, thereby improving user convenience.

The effects of the present disclosure are not limited to the effects mentioned above, and other effects not mentioned will be clearly understood by those skilled in the art from the description.

What is claimed is:

1. A device for compliance requirement analysis and inspection automation, comprising:
an input module configured to collect regulatory data on personal information by country;
an external device including a mobile device, and a communication module configured to transmit and receive the regulatory data;
a memory configured to store at least one process for performing a compliance requirement analysis and inspection automation operation and storing input and data from a compliance manager; and
a processor configured to perform an operation according to the process,
wherein the processor is configured to:
classify and relearn a policy tag based on the regulatory data collected through the input module,
analyze at least one of a company's contract, a term and condition, a policy, a guideline, or a personal information processing policy included in the regulatory data to classify the company's security requirement into a personal information lifecycle and a security control item,
verify compliance with the security requirement; and
manage risk assessment and risk management based on the verified result.

2. The device of claim 1,
wherein the processor is configured to:
perform at least one of crawling, upload, link registration, and input of the regulatory data,
derive a key keyword for each provision of the regulatory data, and assign a tag for personal information regulation, and
calculate a similarity of the tag content.

3. The device of claim 2,
wherein the processor is configured to:
based on an update occurring to the regulatory data, assign a tag to the updated regulatory data, and
calculate a similarity between the updated provision in the updated regulatory data and an existing provision.

4. The device of claim 1,
wherein the processor is configured to:
investigate a personal information protection regulation by country, and
classify the investigated personal information protection regulation into a micro-regulation or common regulation.

5. The device of claim 1,
wherein the processor is configured to:
map the security requirement with a result value of a previously analyzed security risk,
compare the result value with a reference value of the security requirement,
based on the result value being greater than or equal to the reference value, classify the compliance as being met or requiring verification,
based on the result value being less than the reference value, classify the compliance as not being met or requiring verification.

6. The device of claim 5,
wherein the processor is configured to:
based on the result value being requiring verification, calculate the result value by mapping the result value of another module or receive an input value from the compliance manager.

7. The device of claim 1,
wherein the processor is configured to:
map the security requirement with a result value of a previously analyzed security risk, and
calculate a risk level based on the mapped result,
wherein the risk level includes at least one of a possibility of fine, a risk of regulatory violation, or a risk of personal information leakage.

8. The device of claim 7,
wherein the processor is configured to:
receive a person responsible for performing a risk action corresponding to the risk level, a deadline, a priority, and a risk level, and
transmit a message including a risk action detail to a device of the compliance manager.

9. The device of claim 8,
wherein the processor is configured to manage the risk level by changing a status to risk action completed based on a risk action trigger occurring.

10. A method for compliance requirement analysis and inspection automation, performed by a processor of a device, comprising:
collecting regulatory data on personal information by country;
classifying and relearning a policy tag based on the collected regulatory data;
analyzing at least one of a company's contract, a term and condition, a policy, a guideline, or a personal information processing policy included in the regulatory data to classify the company's security requirement into a personal information lifecycle and a security control item;
verifying compliance with the security requirement; and
managing risk assessment and risk management based on the verified result.
